(19) United States
(12) Patent Application Publication
(10) Pub. No.: US 2003/0032476 A1
(43) Pub. Date: Feb. 13, 2003

(54) Methods and apparatus for facilitating the provision of a benefit to a player of a gaming Web site

(76) Inventors: Jay S. Walker, Ridgefield, CT (US); James A. Jorasch, Stamford, CT (US); Russell P. Sammon, San Francisco, CA (US); Geoffrey M. Gelman, Stamford, CT (US); Vikram R. Dendi, Pasadena, CA (US); Magdalena M. Fincham, Norwalk, CT (US)

Correspondence Address: Magdalena M. Fincham, Walker Digital Management, LLC, Five High Ridge Park, Stamford, CT, 06905, US

(21) Appl. No.: 10/267,651

(22) Filed: Oct. 8, 2002

Related U.S. Application Data
(63) Continuation-in-part of application No. 09/274,281, filed on Mar. 22, 1999.
(63) Continuation-in-part of application No. 09/219,267, filed on Dec. 23, 1998.
(60) Provisional application No. 60/328,066, filed on Oct. 9, 2001.

(51) Int. Cl. G06F 17/60; A63F 9/24; A63F 13/00; G06F 17/00; G06F 19/00

(52) U.S. Cl. 463/25; 705/14; 705/26

(57) ABSTRACT

Systems and methods are disclosed wherein, in accordance with one or more embodiments of the present invention, a player of a gaming Web site may be presented with an offer. Such an offer describes a benefit to be provided to the player (e.g., a more favorable outcome in a game of the gaming Web site or a waiver of an entry fee to play on the gaming Web site) in exchange for the player's commitment to an activity. The activity typically benefits a subsidizing entity, that provides a subsidy in exchange for an offer defining the activity being presented to a player and/or being accepted by a player.

### RELATED APPLICATIONS

This application claims the benefit of priority of U.S. Provisional Patent Application Serial No. 60/328,066, filed Oct. 9, 2001, the content of which is incorporated by reference herein for all purposes.

This application is a continuation-in-part application of the following commonly-owned, co-pending U.S. Patent Applications, the content of each of which is incorporated by reference herein for all purposes:

(i) U.S. patent application Ser. No. 09/274,281 (filed Mar. 22, 1999; and

(ii) U.S. patent application Ser. No. 09/219,267 (filed Dec. 23, 1998).

This application is related to the following commonly-owned, co-pending U.S. Patent Applications, each of which is incorporated by reference herein for all purposes:

(i) U.S. patent application Ser. No. 09/553,087 (filed Mar. 22, 2000);

(ii) U.S. patent application Ser. No. 09/579,215 (filed May 26, 2000);

(iii) U.S. patent application Ser. No. 09/282,747 (filed Mar. 31, 1999); and

(iv) U.S. patent application Ser. No. 09/322,351 (filed May 28, 1999).

### BACKGROUND OF THE INVENTION

The present invention relates to methods and apparatus for providing a benefit to a player of a gaming Web site. Further, the present invention relates to means of marketing products and services to such players.

Entities managing gaming Web sites are always looking for means of acquiring additional revenue. Increasing entry fees for game play as a means for increasing revenue is limited by players' willingness to pay higher entry fees rather than foregoing play. Lowering or foregoing entry fees, while attracting players, typically results in decreased revenue for the gaming Web site and makes it difficult to maintain a profitable business model. Further, attracting players typically requires prizes of sufficient value. Increasing the value of a prize or the number of available prizes that can be won at a gaming Web site will typically attract more players. However, for many gaming Web sites the value of the potential prizes or the number of available prizes offered is constrained by the Web site's ability to fund the prizes.

Players are always looking for means of avoiding or lowering entry fees for gaming Web sites. Players are also always looking for ways to increase the value of a prize they have won or are attempting to win, increase the number of prizes they may potentially win, and increase the number of times they win a prize. However, players have limited means for avoiding or lowering entry fees for gaming Web sites and typically cannot increase the value of a prize or the number of prizes available to them or number of times they win a prize other than paying higher entry fees (e.g., in order to gain access to better prizes) or increasing their skill level (e.g., in order to gain access to better prizes or to win prizes more often). Unfortunately, many players do not play often enough or long enough to substantially increase their skill because of their inability or unwillingness to pay a significant amount in entry fees. Similarly, many players do not gain access to more valuable prizes or more prizes because they are unwilling or unable to pay higher entry fees. Additionally, players who do not do well when playing a game have a tendency not to come back to the gaming Web site (especially if they are required to pay an entry fee) because they are discouraged by their lack of initial success.

Accordingly, a need exists for a means of helping entities that manage gaming Web sites to obtain additional revenue without simply raising entry fees and thus risking alienating customers. A need also exists for a means of helping gaming Web sites fund more valuable and/or additional prizes without incurring significant additional expenditures. A need also exists for a means of aiding players who do not do well when playing a game on a Web site such that they are not discouraged from returning to the Web site and for providing a means for players to increase their enjoyment of a gaming Web site by providing access to better or more valuable prizes, more frequent wins, and lowering or waiving entry fees (without making the business unprofitable for the gaming Web site operator).

### BRIEF DESCRIPTION OF THE DRAWINGS

FIG. 1 is a block diagram of a system consistent with an embodiment of the present invention.

FIG. 2 is a block diagram of an embodiment of a device of the system of FIG. 1.

FIG. 3 is a table illustrating an exemplary data structure of a subsidy database for use in an embodiment of the present invention.

FIG. 4 is a table illustrating an exemplary data structure of a player database for use in an embodiment of the present invention.

FIG. 5 is a table illustrating an exemplary data structure of a trigger database for use in an embodiment of the present invention.

FIG. 6 is a table illustrating an exemplary data structure of an offer database for use in an embodiment of the present invention.

FIG. 7 is a table illustrating an exemplary data structure of an offer tracking database for use in an embodiment of the present invention.

FIG. 8 is an exemplary Web page depicting instructions for an exemplary gaming Web site which may utilize offers in accordance with embodiments of the present invention.

FIG. 9A and FIG. 9B are a flowchart illustrating a process that may be performed with the system of FIG. 1.

### DETAILED DESCRIPTION OF THE INVENTION

Most companies and marketers are always looking for effective means of acquiring new customers and retaining current customers. Traditional methods of advertising have limited effectiveness because in today's aggressive marketing world customers are constantly bombarded with advertisements. Further, customers are typically not sufficiently personally motivated to respond to traditional advertisements when they perceive them.

Applicants have recognized that various companies set aside a customer acquisition budget and/or a customer retention budget. The monies in such budgets are expended on promotional efforts aimed at attracting new customers for a business and convincing existing customers of a business to remain customers of that business. Typically, such promotional efforts consist of advertising through various media (e.g., television, radio, newspapers, billboards). Sometimes, attempts are made at increasing the effectiveness of such advertising by targeting it at customers that fit a certain profile (e.g., direct mailings and television advertisements aired during particular shows based on demographic information). However, even such targeted advertising does not result in a sufficiently high response rate.

Applicants have also recognized that whether a person will respond to an advertisement typically depends on whether the person is in some manner personally motivated to respond to an advertisement at the time he or she is exposed to it. For example, an advertisement for a particular product or service will typically be more effective when viewed by a person considering a purchase of the product or service. In another example, offering a person a discount on a product while the person is in the process of purchasing the product (e.g., in exchange for the person's agreement to view an advertisement or purchase another product) is particularly effective because the person is motivated at that particular time to obtain the discount and reduce the cost incurred for purchasing the product. Methods that take advantage of the latter type of motivation are disclosed in co-pending U.S. patent application Ser. No. 09/282,747, filed Mar. 31, 1999, which is incorporated by reference herein in its entirety for all purposes. There is a need for methods that make more effective use of the customer acquisition and customer retention budgets of businesses.

Applicants, in prior U.S. Patent Applications, have recognized that presenting a customer with an offer for a benefit that allows a customer to avoid at least a portion of a transaction cost while the customer is completing a transaction is an effective method of marketing products and services to customers. For example, in U.S. patent application Ser. No. 09/282,747, Applicants have disclosed embodiments wherein a customer at a point-of-sale is presented with an offer that allows the customer to obtain the product or service the customer is in the midst of purchasing without paying anything for it, if the customer commits to an activity in lieu of the payment. For example, a customer purchasing a book at an online bookstore may be presented with an offer that allows the customer to obtain the book for free, if the customer commits to a free trial subscription to a magazine. Applicants have recognized that customers in such situations are particularly motivated to accept such an offer in order to avoid the cost of what it is they are purchasing.

Applicants have also recognized that some businesses would be willing to spend at least a portion of their customer acquisition and/or customer retention budgets on presenting such offers to customers. For example, a magazine publisher may be willing to pay the online bookstore the price of the book (e.g., plus an extra bonus amount) in exchange for the ability to present the offer for the free trial subscription to the customer and/or in exchange for the customer's acceptance of the free trial subscription. This is true because a magazine publisher recognizes that a customer who receives a magazine as part of a free trial subscription has a likelihood of subscribing to the magazine after the trial is over. This is further true because, in the magazine industry, the magazine publisher's revenues from advertisers increase as the number of readers of the magazine increase.

Applicants have further recognized that players of gaming Web sites, similarly to customers at retailers, would be personally motivated to accept offers as described herein. This personal motivation of a player of a gaming Web site may be harnessed in order to increase the effectiveness of the marketing of certain products and services. This may be done by marketing products and services to players of a gaming Web site at times when the players are particularly motivated to obtain a particular benefit (such times include times when a player is not actually visiting or logged onto a gaming Web site). Players of gaming Web sites, for example, desire to (i) avoid or decrease entry fees, (ii) increase the value of prizes they have won (e.g., by trading their prize in for one of a higher value), (iii) have access to more available prizes, and (iv) increase their score or improve an outcome for a game they are playing. Accordingly, Applicants have recognized that many players of gaming Web sites would be willing to commit to an activity in exchange for a benefit which comprises a realization of at least one of the players' desires, such as one of the ones described above (e.g., waiver of entry fee, increase in value of prize, etc.).

Accordingly, Applicants disclose herein a system for presenting offers to players of a gaming Web site. An offer, as used herein, comprises an offer for a benefit to be provided to a player of a gaming Web site in exchange for the player's commitment to an activity. The offer is typically funded by a subsidizing entity (e.g., a subsidizing entity provides payment to the gaming Web site in exchange for the provision of the benefit to the player and the player's commitment to the activity). A subsidizing entity ia also referred to a subsidizer herein. An activity defined by an offer typically benefits the subsidizing entity associated with the offer. For example, a subsidizing entity that comprises a magazine publisher may benefit from acquiring a new customer when a player accepts an offer that defines signing up for a free trial subscription to a magazine of the publisher as the activity.

In general, in an embodiment of the present invention a player of a gaming Web site is presented with an offer. The offer defines a benefit to be provided to the player in exchange for the player's commitment to an activity. The benefit may comprise, for example, a free entry into a game of the gaming Web site or a favorable outcome for a game of the gaming Web site. In another embodiment, the benefit may be an increase in a value of a prize won by the player or another benefit. The activity may comprise an activity that benefits a business or marketer by promoting a product or service (e.g., an activity may comprise filling out an application for a credit card, listening to an advertisement, or agreeing to a trial subscription to a magazine). If the player desires to accept the offer, the player indicates an acceptance of the offer and thus commits to the activity defined by the offer. An indication of the player's acceptance of the offer may be stored in a memory (e.g., of a computing device operated by a gaming Web site operator or another entity). The player may then be provided with the benefit. It should be noted that the benefit may be provided to the player before and/or after the player fulfills his commitment to the activity. Further, in one embodiment the player's acceptance of the offer may comprise a fulfillment of the activity defined by the offer. For example, an activity may comprise agreeing to accept a trial membership to a business. In such an example, the player may be considered to have signed up for the trial membership upon accepting the offer and thus to have fulfilled his commitment to the activity upon accepting the offer. For example, the gaming Web site operator may satisfy the administrative details of signing the player up for the membership once the player indicates acceptance of the offer.

In one, illustrative example of the present invention, a player may be logged on to a gaming Web site that features an online version of The Price Is Right™ game. In this game, players may attempt to win discounts for purchases at local merchants by participating in various games. The players may also be required to pay an entry fee for playing at least one such game or attempting to win one such discount. Further, once the players win the discount, the players may be presented with an opportunity to select which local merchant they desire to utilize the discount with and/or which product or service of the local merchant they desire to utilize the discount for. In such a game, a player may be presented with an offer in accordance with the present invention at various points in the game. For example, the player may be presented with an offer at a time when the player first logs onto the Web site and the offer may define a benefit that is a waiver or reduction in the entry fee for playing the game (e.g., the benefit may comprise a free pass or set of free passes for playing the game). In another example, the player may be presented with an offer after having completed a game, wherein the offer defines a benefit that is a further reduction in a discount that the player earned as a result of playing the game (e.g., the offer may define a benefit of a more favorable outcome in the game, which (when applied to the earned discount) would result in a higher discount earned). In yet another example, the player may be presented with an offer when the player is selecting which local merchants and/or products to utilize the earned discount for (e.g., the offer may define a benefit of making more desirable merchants and/or products or services available to the player). In yet another example, a player may be presented with an offer while playing a game, wherein the offer defines a benefit that is an “intra-game” benefit (i.e., a benefit that comprises a change in a component of playing the game). Such a benefit may not have actual value outside of the game itself. For example, a player playing a role-playing game may be provided with a benefit that comprises an extra skill for the player's avatar in the game.

Applicants have also recognized that local merchants (e.g., merchants owned by private individuals that are not part of a nationwide chain) typically have a limited budget for attracting or retaining customers and are thus always looking for more efficient and effective methods for spending such budgets. Accordingly, in one embodiment, Applicants envision the systems and methods of the present invention being utilized by local merchants as a means of effectively attracting and retaining customers by providing products and services as prizes on a gaming Web site. For example, local merchants can offer products and services at discount prices as prizes on a gaming Web site in accordance with embodiments of the present invention in lieu of, or in addition to, offering such products and services at a discount through traditional promotions such as coupons and sales advertised through other venues (e.g., coupons in flyers distributed in the merchant's community). Such discounts are likely to be utilized and thus more effective at attracting customers for a merchant because the player to whom the discount is provided “earns” the discount by playing games on a gaming Web site. A person that has exerted himself in some manner to obtain a discount is more likely to utilize the discount than a person that receives such a discount in a traditional manner (e.g., via a mass mailer).

The above examples, and all other examples herein, are presented for illustrative purposes only and should not be construed as limiting in any manner. Further embodiments and details of the present invention may be appreciated with reference to the figures below. It should be noted that the terms “an embodiment”, “some embodiments”, “embodiment”, “embodiments” and “one embodiment”, as used herein, mean “one or more embodiments” unless expressly specified otherwise.

Devices

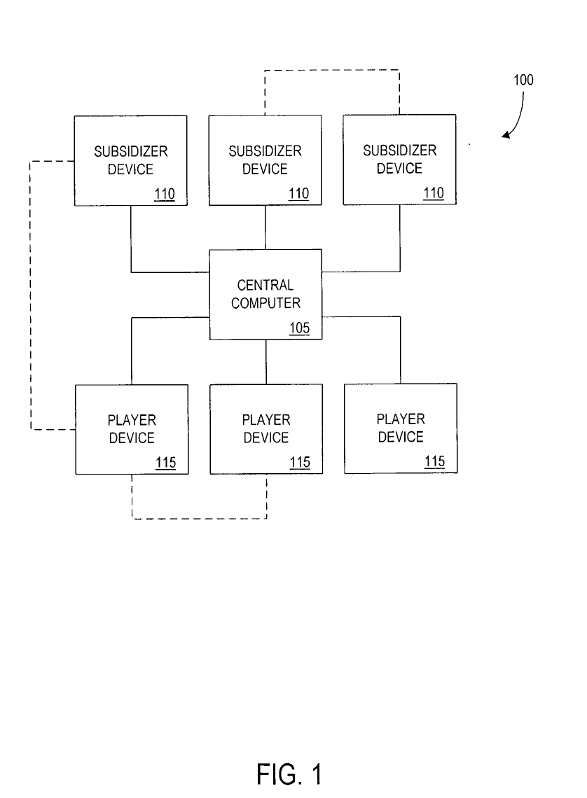

Referring now to FIG. 1, a system 100 according to an embodiment of the present invention includes a central computer 105 that is in communication, via one or more communications networks, with one or more subsidizer devices 110 (e.g., a server computer operated by or on behalf of a subsidizing entity or a personal computer operated by a local merchant that is a subsidizing entity), and with one or more player devices 115. The central computer 105 may communicate with the devices 110 and 115 directly, via the Internet, via a LAN, via a WAN, via a wireless medium, via a wired medium or via any appropriate communications means or combination of communications means. Each of the devices 110 and 115 may comprise computers, such as those based on the Intel® Pentium® processor, that are adapted to communicate with the central computer 105. Any number of devices 110 and 115 may be in communication with the central computer 105.

Communication between the devices 110 and 115 and the central computer 105 may be direct or indirect, such as over the Internet through a Web site maintained by central computer 105 on a remote server or over an on-line data network including commercial on-line service providers, bulletin board systems and the like. In yet other embodiments, the devices 110 and 115 may communicate with central computer 105 and/or with one another over RF, cable TV, satellite links and the like.

The communication network(s) via which the central computer 105 and the devices 110 and 115 communicate may permit or facilitate communication between various devices in communication therewith. For example, (i) the central computer 105 may transmit and/or receive information to/from a player device 115; (ii) the central computer 105 may transmit and/or receive information to/from a subsidizer device 110 (e.g., information about an accepted offer); (iii) a player device 115 may transmit and/or receive information to/from a subsidizer device 110 (e.g., information about a purchase completed by a customer); (iv) a first player device 115 may transmit and/or receive information to/from a second player device 115; and (v) a first subsidizer device 110 may transmit and/or receive information to/from a second subsidizer device 110. Additional forms of communication will be readily apparent to those of ordinary skill in the art.

Some, but not all, possible communication networks include: a local area network (LAN), a wide area network (WAN), the Internet, a telephone line, a cable line, a radio channel, an optical communications line, and a satellite communications link. Possible communications protocols include: Ethernet, Bluetooth™, and TCP/IP. Communication may be encrypted to ensure privacy and prevent fraud in any of a variety of ways well known in the art. It should be noted that one set of devices of system 100 may communicate with each other over one type of communications network (e.g., the central computer 105 and the subsidizer devices 110 may communicate over a telephone line) while another set of devices of system 100 may communicate with each other over another type of communication network (e.g., the central computer 105 may communicate with the player devices 115 over a cable line).

Those skilled in the art will understand that devices in communication with each other need not be continually transmitting to each other. On the contrary, such devices need only transmit to each other as necessary, and may actually refrain from exchanging data most of the time. For example, a device in communication with another device via the Internet may not transmit data to the other device for weeks at a time.

The central computer 105 may function as a “Web server” that generates Web pages (documents on the Web that typically include an HTML file and associated graphics and script files) that may be accessed via the Web and allows communication with the central computer 105 in a manner known in the art.

Any or all of the subsidizer devices 110 may comprise, for example, computer servers, conventional personal computers, portable types of computers, such as a laptop computer, a palm-top computer, a hand-held computer, a Personal Digital Assistant (PDA), a landline telephone, or a cellular telephone. Generally, a subsidizer device 110 may comprise any device that is operable to communicate with at least central computer 105 in accordance with an embodiment of the present invention. It should be noted that a first subsidizer device 110 may comprise a first type of computing device (e.g., a server computer), while another subsidizer device 110 may comprise a second type of computing device (e.g., a laptop computer). The subsidizer devices 110 may or may not be operable to communicate with one another. Any or all of the subsidizer devices 110 may include one or more input devices and one or more output devices.

Any or all of the player devices 115 may comprise, for example, a personal computer, a laptop computer, a personal digital assistant, a landline telephone, a cellular telephone, a video game terminal, a set-top box for a television, a pager, or a combination thereof. Generally, a player device 115 may comprise any device operable to facilitate the play of a game by a player on a gaming Web site. Any or all of the player devices 115 may include one or more input devices such as a computer keyboard, a keypad, a computer mouse, a touch screen, a microphone, a video camera, a bar code reader, a magnetic stripe reader, a biometric input device (e.g., a fingerprint reader, retinal scanner), an infra-red port (e.g., for communicating with a customer device), an electronic signature pad, a voice recognition module, and/or any other input device (e.g., for communicating information related to an offer and/or a game being participated in by a player). Any or all of the player devices 115 may include one or more output devices such as a screen and/or printer for conveying information to a player operating the player device (e.g., for displaying an offer).

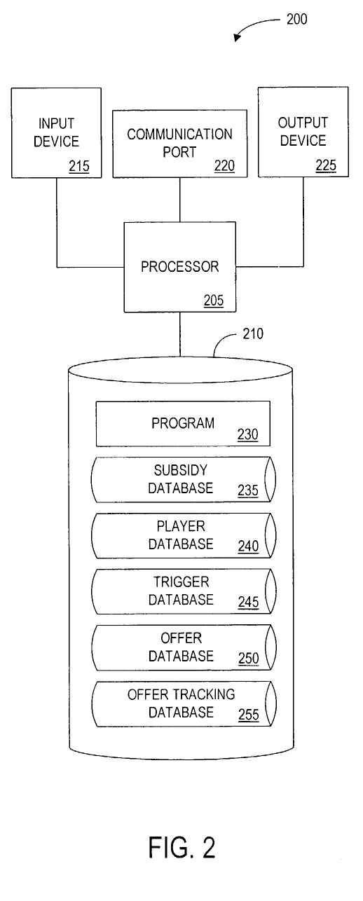

Referring to FIG. 2, an embodiment 200 of the central computer includes a processor 205 (such as one or more Intel® Pentium® processors), memory 210, one or more input devices 215 and one or more output devices 225. In one embodiment, the central computer comprises one or more computers, such as server computers.

An input device 215 may comprise any device via which data may be input to central computer 200. Examples of an input device 215 (and any input device of a computing device described herein) include, but are not limited to, a computer keyboard, a keypad, a computer mouse, a touch screen, a microphone, a video camera, a bar code reader, a magnetic stripe reader, a biometric input device (e.g., a fingerprint reader, retinal scanner), an infra-red port (e.g., for communicating with a customer device), an electronic signature pad, and a voice recognition module. An input device 215 may be operated by a person (e.g., an employee of an entity operating a gaming Web site and/or subsidizer).

An output device 225 may comprise any device via which information may be output from central computer 200. Examples of an output device 225 (and any output device of a computing device described herein) include, but are not limited to, a video monitor, a liquid crystal display (LCD) screen, a light-emitting diode (LED), a touch screen, an audio speaker, a servo motor, a dot-matrix printer, a thermal printer, and a coin, coupon, or bill dispenser. An output device may output data in a form readable by a human being and/or a computing device.

The memory 210 stores a program 230 for controlling the processor 205. The processor 205 performs instructions of the program 230, and thereby operates in accordance with the present invention, and particularly in accordance with the methods described in detail herein. The program 230 may be stored in a compressed, uncompiled and/or encrypted format. The program 230 furthermore includes program elements that may be necessary, such as an operating system, a database management system and “device drivers” for allowing the processor 205 to interface with computer peripheral devices. Appropriate program elements are known to those skilled in the art, and need not be described in detail herein.

According to an embodiment of the present invention, the instructions of the program 230 may be read into a main memory from another computer-readable medium, such from a ROM to RAM. Execution of sequences of the instructions in program causes processor 205 to perform the process steps described herein. In alternative embodiments, hard-wired circuitry may be used in place of, or in combination with, software instructions for implementation of the processes of the present invention. Thus, embodiments of the present invention are not limited to any specific combination of hardware and software.

The memory 210 also stores a subsidy database 235, a player database 240, a trigger database 245, an offer database 250, and an offer tracking database 255. Each of these databases is described in detail herein. Additional databases or configurations of data may be utilized. The databases described herein are provided for illustrative purposes only and describe some of the embodiments of the present invention.

Note that, according to an embodiment, the central computer 200 is operated by one or more entities who also operate at least one gaming Web site. However, it is important to note that the central computer 200 may also be operated by another party. For example, the central computer 200 may be operated by a third party that facilitates communication between one or more gaming Web site operators who participate in the system of the present invention and subsidizers who provide subsidies.

Databases

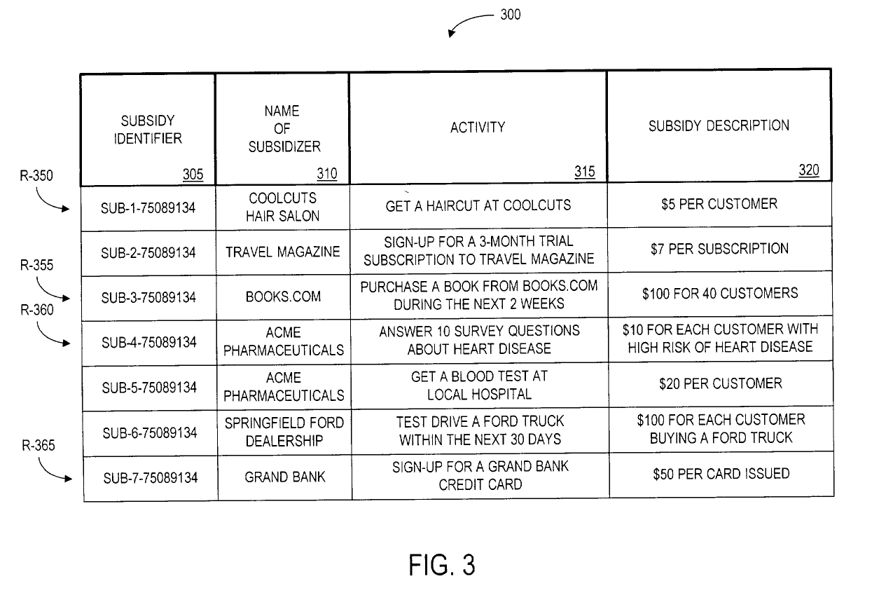

Referring to FIG. 3, a tabular representation 300 of the subsidy database 235 includes a number of example records or entries, including records R-350, R-355, R-360, and R-365. Each of the records defines a subsidy. A subsidy is a payment or other form of consideration provided from a subsidizer to an entity (e.g., an operator of a gaming Web site and/or a player). A subsidy is typically provided in exchange for an offer defining an activity that benefits the subsidizer being presented to a player and/or a player's commitment to such an activity. As discussed herein, the activity is typically paired with a benefit. Those skilled in the art will understand that the subsidy database may include any number of entries.

The tabular representation 300 defines fields for each of the entries or records. The fields specify: (i) a subsidy identifier 305 that uniquely identifies the subsidy; (ii) a name of a subsidizer 310, that identifies the entity providing the subsidy; (iii) an activity 315 associated with the subsidy; and (iv) a subsidy description 320, which describes the subsidy to be provided (e.g., a monetary amount, if the subsidy is a monetary payment) and the condition(s) under which it will be provided.

Note that subsidy identifier 305, and all other identifiers described herein, may comprise alphanumeric strings of characters that uniquely identify something, unless otherwise specified. A subsidy identifier, and all other identifiers described herein, may be generated at a time when they are first used or generated beforehand and selected from a list of available identifiers. Further, an identifier may be selected or at least partially determined based on information provided by an entity such as an operator of a gaming Web site, subsidizer, player, another entity, or combination thereof.

Various conditions under which a subsidy will be provided may be specified in subsidy description field 320. For example, record R-350 indicates that a monetary subsidy in the amount of $5 will be provided for each player that commits to obtaining a haircut at “Coolcuts” hair salon.

Record R-355, on the other hand, specifies a different condition under which a subsidy will be provided. Record R-355 specifies that a monetary subsidy in the amount of $100 will be provided for every forty (40) players who commit to purchasing a book from “books.com” within the next two weeks (e.g., within two weeks of accepting the offer). Thus, if only thirty-nine (39) players commit to this activity, according to record R-355, a subsidy may not be provided.

Record R-360 specifies yet another type of condition under which a subsidy will be provided. Record R-360 specifies that a monetary subsidy in the amount of $10 will be provided for each player that not only answers ten (10) survey questions about heart disease and who also is determined to have a high risk of heart disease (e.g., based on the customer's answers to the survey questions). Thus, record R-360 illustrates that, in some embodiments of the present invention, a player not only has to perform an activity (e.g., answering survey questions) but also otherwise qualify (e.g., have a high risk of heart disease) in order to receive a benefit defined by an offer.

Record R-365 specifies yet another type of condition under which a subsidy will be provided. Specifically, record R-365 specifies that a monetary subsidy in the amount of $50 will be provided for each player that not only signs up for a “Grand Bank” credit card (e.g., fills out an application for the credit card) but also is approved for the credit card (i.e., the credit card is actually issued to the player). Thus, in some embodiments, a subsidizing entity may need to screen a player as an acceptable customer for the subsidizing entity and approve the player before a subsidy is provided.

It should be noted that the activity associated with a subsidy and/or the conditions under which a subsidy will be provided may be determined by, for example, the subsidizer, the gaming Web site operator, and/or a combination thereof. For example, the activity may be specified by the operator of the gaming Web site but contingent on an approval by the subsidizer).

According to one embodiment, a subsidizer may provide a subsidy related to a player's performance of an activity. Such a subsidy may be provided because an activity has value to the subsidizer. For example, a subsidizer may derive value from a player signing up for a new credit card (the issuing bank may be a subsidizer), viewing an advertisement (the advertiser may be a subsidizer), or getting three friends to register with a Web site (the Web site operator may be a subsidizer).

According to an embodiment, a subsidizer provides a subsidy to the operator of the gaming Web site via which an offer based on the subsidy is provided. Examples of subsidies that may be provided to the operators of the gaming Web sites include payments (e.g., in money or an alternate currency like frequent flyer miles), products, services, and other forms of consideration. Note that a subsidy may be monetary and/or non-monetary. Examples of non-monetary subsidies include a credit card company giving an operator of a gaming Web site a discount on credit card transaction fees. Further, subsidy values may be based on a variety of factors, including those used in determining an offer, as described herein.

According to an embodiment, a subsidizer provides a subsidy directly to a player. In this case, the subsidy provided to the player may be the benefit that is provided to the player. In another embodiment, the subsidy may be provided to the player in addition to another benefit being provided to the player.

According to an embodiment, the central computer 105 may communicate with a subsidizer device 110 to determine information about subsidies. For example, the central computer 105 may negotiate with gaming Web site operators to develop subsidy offers, develop the language of the offers and associated graphics, and handle back office billing and penalties associated with the offers. In addition, the central computer 105 may store information about subsidizers in a subsidizer database (not shown).

Note that a single subsidy may be provided for multiple activities performed by one or more players or multiple obligations being committed to by one or more players (“en masse”). For example, a subsidizer may pay a gaming Web site operator $10,000 to have players view an aggregate of 100,000 minutes of advertisements. Lump sum payments may be more convenient for companies with large marketing budgets.

Note that the value of a subsidy may be determined using a mathematical function. For example, a credit card company may provide a subsidy of $10 for signing up a player for a credit card plus 1% of the revenues from the player's annual purchases.

Subsidies may be provided at various times. For example, a subsidy may be provided before, after or substantially simultaneously with an activity being performed by a player. In one example, a subsidizer may pay $500 at the start of a month in order for a gaming Web site operator to display advertisements to 20% of its players. In another example, a subsidizer may pay $603.15 at the end of the month for a gaming Web site operator having shown 4021 advertisements to players at $0.15 per advertisement.

Note that subsidy payments may be provided to various parties depending on who operates the central computer 105 and/or who presents offers to players. In one example, gaming Web sites may each be operated by one or more entities, subsidies may be provided by one or more subsidizers, and the central computer 105 may be operated by a third party (e.g., a clearinghouse system). In this example, subsidy payments may be provided to the operator of the central computer 105. In another example, portions of a subsidy payment may be provided to more than one entity (e.g., to an operator of a gaming Web site and to another entity operating the central computer 105). In yet another example, the central computer 105 may be operated by an entity that also operates a gaming Web site and subsidy payments are provided to this entity.

In one embodiment, information stored in a subsidy database (e.g., such as the one illustrated in FIG. 3) is received from subsidizers. For example, a subsidizer may use a subsidy device 110 to communicate information about a subsidy to the central computer 105 (which may store or have access to the subsidy database). In a second example, a subsidizer may communicate information about a subsidy to a party operating the central computer 105, and then the party may enter information about the subsidy into the central computer 105. In various embodiments of the invention, subsidizers or other parties may add, remove, and modify subsidy agreements that are stored in the subsidy database.

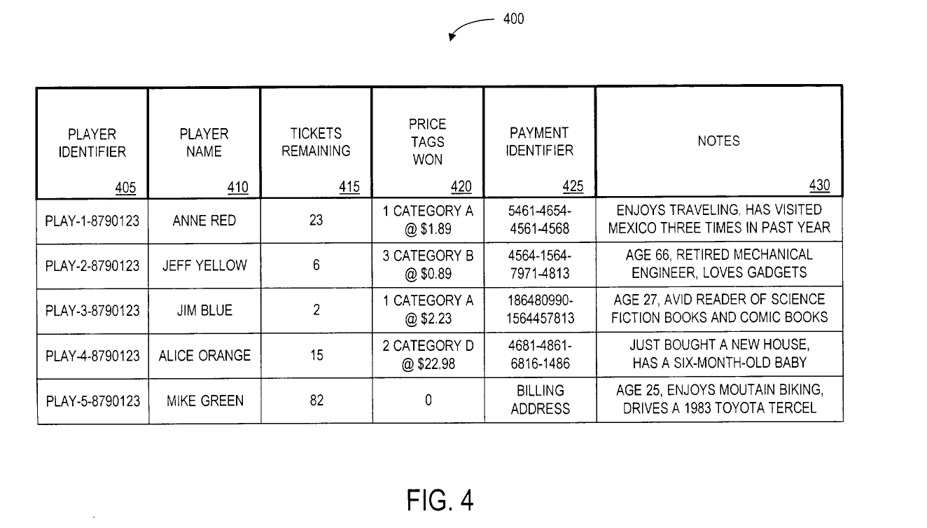

Referring now to FIG. 4, a tabular representation 400 of the player database 240 includes a number of example records or entries. Each of the records defines a player that participates in, has participated in, or may potentially participate in games of a gaming Web site. Those skilled in the art will understand that the player database may include any number of entries.

The tabular representation 400 also defines fields for each of the entries or records. The fields specify: (i) a player identifier 405; (ii) a player name 410; (iii) an indication of tickets remaining 415 (e.g., wherein a ticket is an entry pass into a game of the gaming Web site); (iv) an indication of price tags won 420 (e.g., for use in games wherein a player earns reductions in the value of price tags, as described herein); (v) a payment identifier 425 (e.g., for use in charging fees to a player and providing payment to a player); and (vi) notes 430.

In some embodiments the player identifier 405 and the player name 410 may comprise the same information and a single field may be used to store that information. In some embodiments the player identifier 405 and the payment identifier 425 may comprise the same information and a single field may be used to store that information.

A record in the player database may be opened when a player first registers with a gaming Web site (e.g., as a member), when a player first plays a game on a gaming Web site, when a player first accepts an offer at a gaming Web site, or another time.

The notes field 430 may store an indication of a characteristic of a player or other data associated with a player. The information stored in field 430 may be utilized, for example, in determining which offer to present to a player, whether a particular subsidizer would be interested in acquiring a particular player as a customer, and/or what activity or benefit to include in an offer to be presented to the player. The information stored in notes field 430 may be acquired, for example, via a survey answered by the player. Alternatively, an employee of a gaming Web site operator utilizing the player database 400 may enter information into the notes field 430 for a particular player as the employee learns information about the player (e.g., through monitoring online conversation between the player and another player). In one embodiment, the information in notes field 430 may be purchased from outside sources (e.g., from mailing list services) and/or obtained from public records.

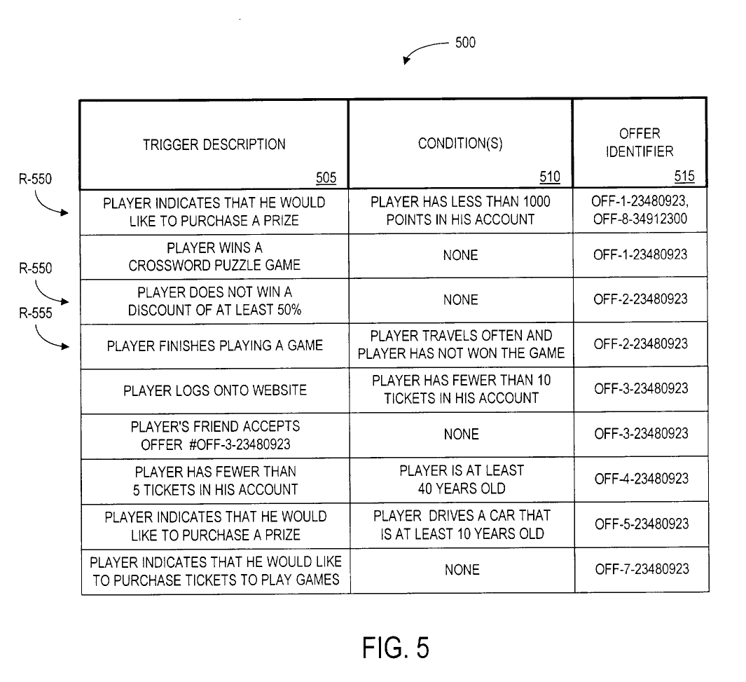

Referring now to FIG. 5, a tabular representation 500 of the trigger database 245 includes a number of example records or entries, including record R-550, record R-555, and record R-560. Each of the records defines a trigger that may cause an offer to be output to a player. Those skilled in the art will understand that the trigger database may include any number of entries.

The tabular representation 500 also defines fields for each of the entries or records. The fields specify: (i) a trigger description 505; (ii) a condition(s) 510 associated with the trigger, if any; and (iii) offer identifier(s) 515 which identify one or more offers associated with a trigger.

A trigger may be any event, circumstance, or condition that results from a player's activities, e.g., at a gaming Web site. The central computer 105 may identify a player to receive an offer in response to a trigger (also referred to herein as a “trigger event”). A trigger database may be utilized to determine whether a trigger event has occurred and which offer should be presented to a player once it is determined that a trigger event has occurred. Information may be entered and/or removed from the trigger database by, for example, an employee of an operator of the central computer (e.g., an employee of a gaming Web site operator), and/or an employee of a subsidizer.

The trigger description 505 describes the event, circumstance, or condition that constitutes a particular trigger. Examples of various types of events, circumstances, or conditions that may constitute a trigger are described herein.

The condition(s) field 510 indicates a condition, if any, that must be true (e.g., at the time of the trigger being determined) in order for the associated offer to be presented to a player. The offer(s) field 515 indicates one or more offer identifiers that each identify an offer to be presented to a player upon the occurrence of the associated trigger if the associated condition, if any, is true. For example, record R-550 defines that if a player indicates that he would like to purchase a prize (the trigger event), then offer “OFF-1-23480923” is to be presented to the player if the player has less than 1000 points in his account (the condition that has to be true in order for the corresponding offer to be presented to the player).

If more than one offer identifier is stored in the offer(s) field 515 (as exemplified by record R-550), a subset (e.g., one) of the offers may be selected for presentation to the player. If more than one offer is selected for presentation to the player, the player may have an option to select one of the offers that is presented to him.

Note that no condition may be specified as being associated with a particular trigger. For example, record R-555 indicates that no condition is associated with the trigger event of a player not winning a discount of at least 50% (in embodiments where a discount on a product or at a retailer is a prize). Accordingly, if this trigger occurs, offer “OFF-2-23480923” is presented to a player, without the need to determine whether any other condition is true.

Note that more than one condition may be associated with a trigger. Record R-560, for example, illustrates two conditions as being associated with a trigger. In such embodiments all of the conditions specified as being associated with a trigger may need to be true, or a subset of the conditions (e.g., one of the conditions) may need to be true in order for the associated offer(s) to be presented to the player.

Triggers may be related to gaming activities performed by a player. Examples of such triggers include, but are not limited to, whether the player (i) registers as a member of a gaming Web site; (ii) begins participating in a game at a gaming Web site; (iii) enters his player identifier into the gaming Web site; (iv) provides payment to a gaming Web site (e.g., to pay for an entry fee); (v) wins or earns a prize at a gaming Web site; (vi) obtains a winning outcome at a gaming Web site; (vii) obtains a losing outcome at a gaming Web site (or a losing series of outcomes); (viii) finishes playing a game; (ix) attempts to log off (or logs off) a gaming Web site; (x) accesses a “help” page on a gaming Web site; (xi) obtains an intermediate outcome at a gaming Web site (e.g., a result in an intermediate step of a game); (xii) accesses a predetermined page of a gaming Web site; and/or (xiii) selects a prize from a menu of available prizes.

Triggers may comprise activities related to results of games available on a gaming Web site. Examples of such triggers include, but are not limited to, whether the player (i) wins a game or a round of a game; (ii) loses a game or a round of a game; (iii) wins a plurality of games; (iv) loses a plurality of games; (v) achieves an average score over a plurality of games; (vi) achieves a score that is greater than a threshold value (e.g., more than 1000 points); (vii) achieves a score that is less than a threshold value (e.g., less than 1000 points); (viii) achieves a score that is better than a score achieved by one or more other players; (ix) achieves a score that is worse than a score achieved by one or more other players; (x) wins a prize based on his performance in a game; (xi) does not win a prize based on his performance in a game; (xii) obtains a discount of a predetermined magnitude; and (xiii) does not obtain a discount of a predetermined magnitude.

Triggers may comprise activities related to payment of entry fees on a gaming Web site. Examples of such triggers include, but are not limited to, whether a player (i) is prompted to pay an entry fee; (ii) pays or provides payment for an entry fee (or begins to enter a payment identifier as payment for an entry fee); (iii) does not pay an entry fee (e.g., exits a page of the gaming Web site after being prompted for an entry fee); (iv) opts to split an entry fee with at least one other player; and (v) is prompted to provide a payment identifier. Note that, in one embodiment, a player may be allowed to purchase a pass that entitles the player to play a predetermined number of games on the gaming Web site or participate in games on the gamine Web site over a predetermined period of time. For example, the player may purchase a “season” or “weekly” pass to the Web site or sign up for a subscription to the Web site. In such an embodiment, the player may be provided with a password or other identifier to use as proof of having paid for the pass or subscription. Further, in such embodiments a trigger that is related to payment of an entry fee may comprise the payment of the fee for the subscription or pass and/or the detection of the player's input of the password, which serves as proof a previous payment of a type of entry fee.

According to an embodiment, a player may purchase one or more products and/or services through the central computer 105 (e.g., using an alternate currency obtained by playing games) or otherwise select one or more products as a prize. In such an embodiment, triggers may be related to such products. Examples of triggers relating to selecting products include, but are not limited to, the player (i) indicating that he may be interested in purchasing a product (e.g., by adding it to an electronic shopping cart or clicking on a representation of the product); (ii) viewing information about a product (e.g., by accessing a Web page); (iii) purchasing a product; (iv) selecting a product as a prize; and (v) bidding on a product (e.g., in an embodiment in which players bid on prizes using money or an alternate currency (e.g., such as points) won by playing games).

According to an embodiment, a trigger may be related to a time factor. Examples of triggers related to time include, but are not limited to, (i) a current time being a predetermined time of day, week, month or year (e.g., the player's birthday, tax day, Christmas); (ii) the passage of more than a predetermined period of time during which a player completes a game or set of games; (iii) the passage of more than a predetermined period of time between moves of a player while playing a game; (iv) the passage of more than a predetermined amount of time since a player was last active (e.g., during a particular game, or at the gaming Web site in general); (v) the passage of more than a predetermined period of time during which a player has been continuously logged onto the gaming Web site; (vi) the passage of more than a predetermined period of time since a player last logged onto the gaming Web site; and (vii) the passage of more than a predetermined period of time that a player has been waiting or is expected to wait for a software download.

According to an embodiment, a trigger may be related to the activity of browsing a Web site. Examples of triggers relating to browsing a Web site include, but are not limited to, a player (i) requesting a file (e.g., through http or ftp); (ii) viewing a file (e.g., a Web page); (iii) providing information (e.g., typing a home address, filling out a form); (iv) logging in to a secure section of a Web site; (v) viewing a particular section of a Web site (e.g., the customer service section, or a section that describes a particular game); (vi) leaving a Web site (e.g., logging off); and (vii) viewing or interacting with an advertisement displayed on a Web site (e.g., a banner ad).

According to an embodiment, a trigger may be related to one or more offers. Examples of triggers that are related to one or more offers include, but are not limited to, (i) the player completing an activity defined by an offer previously accepted by the player; (ii) the player not performing an activity defined by an offer previously accepted by the player; (iii) the inventory of offers reaching a certain level (e.g., in an embodiment where only a limited number of offers may be presented); (iv) an activity or benefit being added to an inventory of offers (e.g., to an offer database); and (v) a player accepting or rejecting an offer (e.g., a particular offer or any offer).

According to an embodiment, a trigger may be related to one or more indications from a subsidizer. Examples of triggers relating to one or more indications from a subsidizer include, but are not limited to, (i) a subsidizer indicating a subsidy to the central computer 105 or an operator of a gaming Web site (who may or may not be operating the central computer); (ii) a subsidizer canceling a subsidy; and (iii) a subsidizer indicating that an offer should be made to a player (e.g., to a particular player or to a player who displays a particular characteristic).

According to an embodiment, a trigger may be related to one or more indications from a player. Examples of triggers that relate to one or more indications from a player include, but are not limited to, a player (i) indicating that he would like to receive an offer (e.g., by selecting an offer request area of a Web page); and (ii) a player accepting or rejecting an offer.

According to an embodiment, a trigger may be related to other persons that are associated with a player. For example, an event of a first player winning a prize may trigger an offer to be made to a second player. Examples of other persons associated with the player include, but are not limited to, (i) family members, friends, and other associates of the player; (ii) a person who is playing or has played the same game as the player to whom the offer is to be presented; and (iii) a person who sends instant messages to the player (e.g., while the player is playing the game).

The central computer 105 may receive information about triggers from a variety of sources, including but not limited to player devices, input devices, operators of Web sites, and/or databases accessible by the central computer 105 (e.g., the information about a player's gaming history may be stored in the player database, such as that illustrated in tabular representation 400).

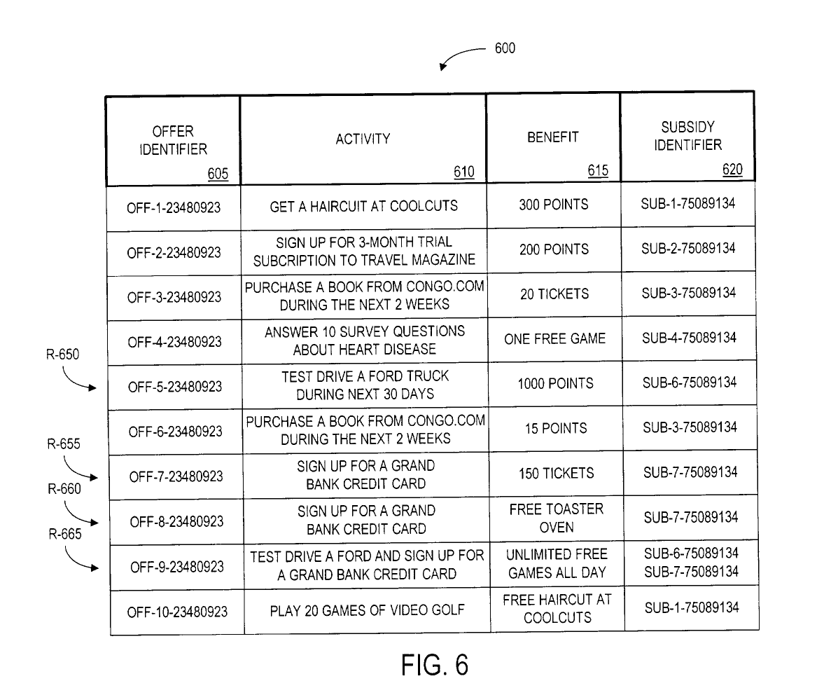

Referring now to FIG. 6, a tabular representation 600 of the offer database 250 includes a number of example records or entries, including record R-650, record R-655, record R-660, and record R-665. Each of the records defines an offer available for presentation to a player. Those skilled in the art will understand that the offer database may include any number of entries. An offer, as used herein, defines at least one benefit to be provided to a player in exchange for the player's commitment to at least one activity.

The tabular representation 600 also defines fields for each of the entries or records. The fields specify: (i) an offer identifier 605 that uniquely identifies an offer; (ii) an activity 610 that describes an activity; (iii) a benefit 615 that describes a benefit; and (iv) a subsidy identifier 620 that identifies a corresponding subsidy.

Note that one or more of the offer identifiers stored in offer identifier field 605 may be one or more of the offer identifiers stored in the offer identifier field 515. In other words, an offer defined in tabular representation 600 as an offer that is available for presentation to a player may be identified in a record of tabular representation 500 as an offer to be presented upon the occurrence of a corresponding trigger and a corresponding condition. Note that one or more of the subsidy identifiers in subsidy identifier field 620 may be one or more of the subsidy identifiers in the subsidy identifier field 305 (FIG. 3). In other words, a subsidy identified in tabular representation 600 as corresponding to an offer may be defined in a record of the subsidy database as illustrated in tabular representation 300.

Note that a single subsidy identifier may correspond to more than one offer identifier. For example, record R-655 indicates that offer identifier “OFF-7-23480923” corresponds to subsidy identifier “SUB-7-75089134” and record R-660 indicates that offer identifier “OFF-8-23480923” corresponds to the same subsidy identifier. Thus, in one embodiment, more than one offer may be determined based on a particular subsidy (e.g., more than one benefit may be paired with the activity corresponding to the subsidy, each pairing comprising a separate offer). Note further that a single offer may correspond to multiple offer identifiers, as illustrated by offer “OFF-9-23480923”.

According to an embodiment, if a player fulfills his commitment to an activity specified in an offer the player accepted, then that player is provided with a benefit defined by the offer. According to an embodiment, a benefit provided to a player may be determined based on the activity performed. For example, the benefit may be based on what activity is performed. For example, a player may be given a choice of visiting a first Web site and visiting a second Web site. If the player visits the first Web site, then he earns a free pass to a game at the gaming Web site. If the player visits a second Web site, then he earns access to a more valuable prize (e.g., which he may trade his currently won prize for).

The benefit, in one or more embodiments, may be based on how an activity is performed. For example, a player may be given the opportunity to earn up to an additional $0.25 discount on a price for a product for every survey question he answers. If the player answers twelve survey questions, then he earns an additional $3.00 discount on the price.

Note that a benefit may be provided to a player by a variety of different parties, including an operator of the central computer 105 (e.g., by crediting a player's financial account); the gaming Web site operator (e.g., if different from the entity that operates the central computer); and/or another party (e.g., a subsidizer, a product manufacturer, a service provider). Note also that a benefit may be funded by a variety of different parties (acting together or alone), such as a gaming Web site operator, a retailer, a manufacturer, a subsidizer, a marketing company or another appropriate entity. Note further that a benefit may be selected for inclusion in an offer by a variety of different parties. For example, a gaming Web site operator and/or a subsidizer may select the benefit to be included in a particular offer.

Various different types of benefits may be defined in an offer. A benefit may be any form of consideration, including: (i) a free pass to play a game or a waiver of an entry fee for playing a game; (ii) access to one or more prizes not otherwise available to the player; (iii) an increase in the value of a prize (e.g., a further increase in a discount earned or a further reduction in a price earned); (iv) access to a bonus feature of a game (e.g., a wild card that allows the player to perform certain activities on the gaming Web site); (v) a favorable outcome in a game; (vi) additional points or other increase in a score earned by the player; (vi) money (e.g., cash, or a credit to a financial account); (vii) products (e.g., a meal, a souvenir watch, a sweatshirt, a magazine subscription); (viii) services (e.g., a haircut, an oil change); (ix) discounts on products or services (e.g., 50% off the list price of a hotel room); (x) alternate currencies (e.g., points or frequent flyer miles); (xi) an entry into a game of chance (e.g., a lottery ticket, a free spin on a slot machine); (xii) an entry into a sweepstakes; and/or; (xiii) another type of consideration.

According to one embodiment, a benefit may be provided to an entity associated with the player (e.g., a friend of the player, a family member, a charity). While providing a benefit to a player's favorite charity or friend may not provide a tangible benefit to the player, the player does receive an intangible benefit (e.g., he may feel altruistic and good-hearted). For this reason, benefits to charities or friends of players may be particularly motivational for a player. According to one embodiment, a benefit provided to a friend of a player may be contingent on the friend performing one or more activities. For example, a player's friend may be asked to perform an activity in order to receive a benefit.

An offer may define more than one benefit. Accordingly, a player may receive multiple benefits. For example, a player may receive multiple benefits for accepting a single offer. A player may accept multiple offers and thereby receive multiple benefits. A player may receive a benefit for himself and two additional benefits for two of his friends. A player may receive multiple benefits for a single offer but at different times. For example, a player may receive a first benefit when accepting an offer and a second benefit upon completing an activity specified in the offer. In some embodiments, even though an offer defines more than one benefit, the player only receives one benefit. For example, the player may select which of the plurality of benefits defined by the offer the player would like (e.g., when accepting the offer or completing his commitment to the activity defined by the offer). Alternatively, which of the plurality of benefits defined by the offer is to be provided to the player may be determined based on other factors. Examples of such factors include, but are not limited to, (i) how well the player performs an activity defined by the offer; (ii) when the player completes the activity defined by the offer; (iii) which of a plurality of activities defined by the offer the player completes; and/or (iv) a characteristic associated with the player.

Note that a benefit may be provided to a player either before or after an activity is performed. For example, a gaming Web site may provide a player with access to additional prizes for a current game if the player agrees to test drive a Ford™ sometime in the next two weeks. In another example, a player may fill out a survey questionnaire (e.g., online); the gaming Web site may then provide the player with a benefit of a favorable outcome (or a more favorable outcome than the player actually received) in a game (e.g., move the player up three places from his current placement in a competition game). Note further that, in one embodiment, a benefit may be provided to a player continuously as long as the player continues to perform an activity (e.g., a player's character in a role playing game may acquire and remain in possession of a skill as long as the player keeps an advertising scroll bar open on his desktop).

Note that if a benefit is provided to a player before an activity is performed, then some players might attempt to cheat the system by accepting an offer, receiving a benefit, and then not performing an activity specified in the offer. One way of discouraging this is to penalize a player if he does not perform an activity as promised. Various methods of penalizing a player who does not perform an activity or otherwise fulfill an obligation the player committed to are described herein.

Note that a benefit may be defined but not particularly specified in the offer that is output to a player. Assume, in one example, that a player of a gaming Web site plays one or more games in order to “earn” a low price (e.g., a price that is less than the normal shelf price) for one or more products or services. In such an example, an offer may define a benefit by stating that a player may be “entitled to an additional decrease of 50% in the price earned”, without actually stating the exact dollar amount of the price the player is to receive as the benefit. In such embodiments, the actual benefit may not be known or knowable until a certain event occurs. For example, in the above example the benefit is not knowable until the player completed playing a game and earns a final price. The 50% additional reduction may then be applied to the earned price.

In other embodiments, an offer may specify the particular benefit that is to be provided to the player once the player commits to the activity defined by the offer. Such embodiments may comprise specifying a benefit that is customized for the particular player or specifying a benefit based on a characteristic of the game the player was participating in when the offer was output. For example, the offer may specify that the player is to receive a benefit comprising an outcome that is more favorable than the outcome the player actually received in the game the player has just finished playing. For example, if the player was playing a game where the player was attempting to land a virtual arrow in the center of a virtual bull's-eye target, and the player landed the arrow in one of the outer-most rings of the bull's-eye, the benefit may comprise moving the player's arrow to the center of the bull's-eye or closer to the center of the bull's-eye. Alternatively, the benefit may comprise changing the outcome of the game such that the effect is as if the player landed the arrow in a more favorable spot of the bull's-eye target, without actually moving the arrow.

Referring again to tabular representation 600 and the activity field 610, it is noted that in order to earn a benefit defined by an offer, a player must perform an activity. Examples of activities include signing up for a new credit card and answering survey questions about a product or service. In many cases, an activity has value to a subsidizer. For example, a credit card issuer may be willing to pay up to $50 to get a player to sign up for a new credit card, since acquiring this player as a customer will likely result in more than $50 of revenue for the credit card issuer.

Note that an activity, as used herein, does not require any physical motion or action on the part of the player. An activity, as used herein, may simply be an obligation that a player is to fulfill, without necessarily requiring any action on the part of the player. For example, a player may accept an offer that defines an activity of agreeing to let the Web site sell or otherwise provide some of the player's personal information to another entity. Such an activity may be thought of as an obligation that the player is to satisfy (rather than an activity that the player is to perform) by accepting the offer that defines it, without requiring any further action on the part of the player.

Activities may be grouped into some exemplary categories, such as: (i) purchasing a product or service; (ii) using a product or service; (iii) selling a product or service; (iv) providing a product or service; (v) providing information; (vi) considering information; and (vii) performing an action. There are many other types of activities and some activities do not fit clearly into any one category.

Examples of activities that comprise purchasing a product or service include: (i) signing up for a magazine subscription; (ii) buying a product from a retailer other than the gaming Web site at which the offer was output; and (iii) purchasing an additional product and/or service from the gaming Web site.

Examples of activities that comprise using a product or service include: (i) receiving a new credit card and/or using a credit card; (ii) using a new long distance telephone provider; (iii) printing at least 100 pages per week from an HPTM laser printer; and (iv) agreeing to receive a free trial subscription to a magazine or service.

Examples of activities that comprise providing a product or service include: (i) providing legal, medical, or another type of advice; and (ii) donating one or more items (e.g., such as an old television set).

Examples of activities that comprise selling a product or service include: (i) selling a used product (e.g., on the eBay™ Web site or another auction or classifieds Web site); and (ii) providing tax or another type of advice at a rate (e.g., $10 per hour).

Examples of activities that comprise providing information include: (i) answering survey questions; (ii) providing product ratings and reviews; and (iii) indicating demographic information, purchasing information or giving permission to access such information.

Examples of activities that comprise considering information include: (i) watching a television commercial or other advertisement; (ii) listening to an audio tape that conveys a specified message (e.g., about the health dangers of smoking cigarettes); and (iii) reading a pamphlet that explains how to use a product.

An example of an activity that comprises performing an action is playing a game of chance or a game of skill. For example, a player may perform an activity of spinning the reels on a virtual slot machine. The player may then win a pricing benefit based on the outcome depicted by the simulated reels. Other examples of activities that comprise performing an action include: (i) applying for a credit card; and (ii) performing a customer-segmenting activity (i.e., an activity that allows a seller to segment its customer base). As an example of the latter type of activity, a seller may segment its customer base by asking a player to perform an activity over an extended period of time (since some players will not have the time to perform such activities).

There may be limitations, conditions, or other restrictions relating to a player's performance of an activity. For example, an activity may include a time-based requirement. For example, a requirement associated with an activity may specify that (i) an activity must be started before a designated time or event (e.g., before the end of a baseball game); (ii) an activity must be started after a designated time or event (e.g., after winning a prize); (iii) an activity must be finished by a designated time or event (e.g., before 6 pm tonight); (iv) an activity must take place during a designated time period (e.g., between 4 am and 8 am); and/or (v) an activity must be performed before a designated occurrence or condition (e.g., before the end of a sale, before the customer visits the gaming Web site again). Record R-650 specifies a time-based requirement on the activity defined by the offer (the player must test drive a Ford™ truck within the next 30 days).

A plurality of activities may be associated with a single offer. In other words, an offer may require that a player perform multiple activities in order to receive a benefit. These activities may be performed sequentially, simultaneously, or in some other fashion. For example, a player may have to answer survey questions online (a first activity) and purchase a product from a specified online retailer (a second activity). Record R-665 defines an offer that specifies two activities.

In accordance with one embodiment, a player may have to perform a repeated activity (e.g., purchasing a product from a retailer at least once a month for a duration of three months; maintaining a balance on a credit card). In such an embodiment, the player may receive a benefit or portion of a benefit before completing any instance of the activity, a benefit or portion of a benefit each time the player completes an instance of the activity, and/or a benefit or portion of a benefit once the player successfully completes the last required instance of the activity.

According to one embodiment, a player's completion of an activity may be determined based on activities of other persons. For example, a player may perform a competitive activity (i.e., an activity where success is determined relative to at least one other person). In such an embodiment, a player may have to win a game or be one of the first ten persons to collect receipts from each of a plurality of specified online retailers. As another example, a player may perform a team activity (i.e., an activity where persons work together to accomplish a common goal).

According to one embodiment, the player may have to perform one or a subset of a plurality of activities. In such embodiments, the player may have a choice of what activity to perform. For example, a player may be required to either test drive a Ford™ Mustang™ or buy a ticket to a boxing match. If the player performs either activity, then this will satisfy the requirements of his offer. In one embodiment the player may be required to select which activity to perform at a time the player accepts the offer defining the activity. In another embodiment, the player may indicate his selection of the activity by performing one of the available activities (i.e., the player's selection will be inferred based on which activity the player performs).

In one embodiment, there may be restrictions as to the time, manner, and place for performing an activity or fulfilling an obligation defined by an offer. For example, a requirement associated with an activity may specify that (i) the activity must be performed while a player is at a retailer, and/or (ii) the activity must be completed in a satisfactory manner. In the latter example, the offer output to the player that defines the activity may specify what constitutes a satisfactory manner.

According to an embodiment, it may be permissible for an activity to have been performed in the past. For example, a player may be asked to perform an activity of purchasing a product. If the player has already purchased the product (i.e., in the past), then this may constitute performance of the activity. In an embodiment, there may be limitations as to the acceptability an activity performed in the past. For example, an activity that occurred more than three (3) months ago may not be acceptable. Note that a player may be asked to provide evidence that he performed an activity in the past (e.g., entering a purchase order number or shipping confirmation number of a previous purchase from an online retailer).

In an embodiment, a player may provide an code to authenticate his performance of an activity. For example, a player may have performed an activity in the past. Based on the player's performance of this activity, an code may be indicated to the player. This code might be, for example, a 10-digit number on a receipt that was e-mailed to the customer or a series of bits on a magnetic stripe card that serves as proof that the player did indeed perform the activity. The player may later use the code to indicate his performance of the activity. According to one embodiment, codes may be produced using a cryptographic protocol to avoid tampering and cheating by players.

According to an embodiment, it may be permissible for a player to make a forward commitment to perform an activity. According to one embodiment, a forward commitment is an agreement to perform an activity at some point in the future. For example, a player may be required to perform an activity of test driving a Ford™ Escort™ at a car dealer that is located near the player's home address (in this example the Ford™ dealer may be a local subsidizer). The player may agree to perform this activity later (e.g., once he finishes playing games on the gaming Web site). Based on this commitment, an immediate benefit may be provided to the player. Note that forward commitments may include time-based requirements and expiration conditions.

According to an embodiment, a forward commitment may be penalty-secured. This means that a player may be penalized for not completing the activity specified in the forward commitment. For example, a player's credit card may be charged a predetermined amount or the value of the benefit previously provided if he does not complete an activity by a specified date. Examples of penalties include monetary penalties that may be charged to a player's credit card, debit card, customer account or other financial account. According to one embodiment, a player may be required to provide a payment identifier (e.g., a credit card number) when signing up for a penalty-secured forward commitment.

Another example of a penalty is a denial of products or services (e.g., the player may not be permitted to accept additional offers or play games on the gaming Web site any more). Penalties that involve denial of products or services may be temporary. For example, a penalty may expire after two months, after the player performs an additional activity, or when some other condition is true. Other examples of penalties include (i) requiring the player to perform one or more additional activities, (ii) publishing the player's name along with an indication that he or she failed to perform an activity as promised (e.g., by posting the player's name and an indication of the failed commitment on a gaming Web site or at a retailer within the player's neighborhood, such as at a retailer at which the player was to perform an activity), and/or (iii) requiring the player to provide another form of consideration (e.g., a monetary amount based on the value of the benefit previously provided to the player).

Penalties may be imposed at various different times or enacted against friends or family of a player instead of, or in addition to, being imposed against the player himself. The central computer, subsidizer device, or another computing device may determine a penalty. The penalty may be specified to the player as part of the offer that is output to the player.

In one embodiment, a player who accepts an offer to perform an activity also performs the activity and receives a benefit. However, activities may be performed by a variety of different persons, including: (i) a person that receives/accepts an offer; (ii) a person that receives a benefit; (iii) a person that participates in a purchase; and/or (iv) at least one other person (e.g. a friend of a player who accepts an offer).

Note that a person who performs an activity may be different from a person who accepts an offer to perform an activity. Note also that a person who performs an activity may be different from a person who receives a benefit. For example, a player may accept an offer that defines a benefit of extra points added to the player's score in a game if one of his friends performs an activity.

In addition, note that a person who performs an activity may be different from both a first person who receives and accepts an offer and a second person who receives a benefit. For example, a woman may accept an offer that requires her husband answer survey questions and provides a discount on video games for her son. In other words, in accordance with some embodiments, “the player” described herein may be one or more persons, and not all persons need to participate in every step of the methods of the present invention.

An activity may be performed by one or more persons. Examples of persons who may perform an activity include a player, friends or family of a player, other players, and other persons that interact with a player who accepts an offer to perform an activity. For example, a player may agree to an offer that requires ten (10) of his friends to perform an activity of subscribing to a specified Internet Service Provider (ISP).

According to one embodiment, a player may receive help in performing an activity. For example, one or more other persons may perform an activity in the place of the activity being performed by the player or in addition to the activity being performed by the player. For example, a player may be required to perform an activity of playing a virtual slot machine at an online casino continuously for four (4) hours. The player may enlist three (3) friends to help him perform this activity (e.g., each person plays the slot machine for one (1) hour). In another example, a player may be required to perform an activity of signing up for three (3) magazine subscriptions. If the player is only interested in receiving two (2) magazines, the player may be allowed to fulfill his obligation to the remaining third subscription by convincing a friend to sign up for the third subscription. In yet another example of how a player may fulfill an obligation with the help of another person, a player may be required to perform an activity of completing a Tae-Bo™ workout. If the player does not enjoy Tae-Bo™ but knows another person who does, the player may be allowed to fulfill his obligation by convincing this other person to perform the workout. Alternatively, it may not be permissible for a player to receive help in performing an activity.

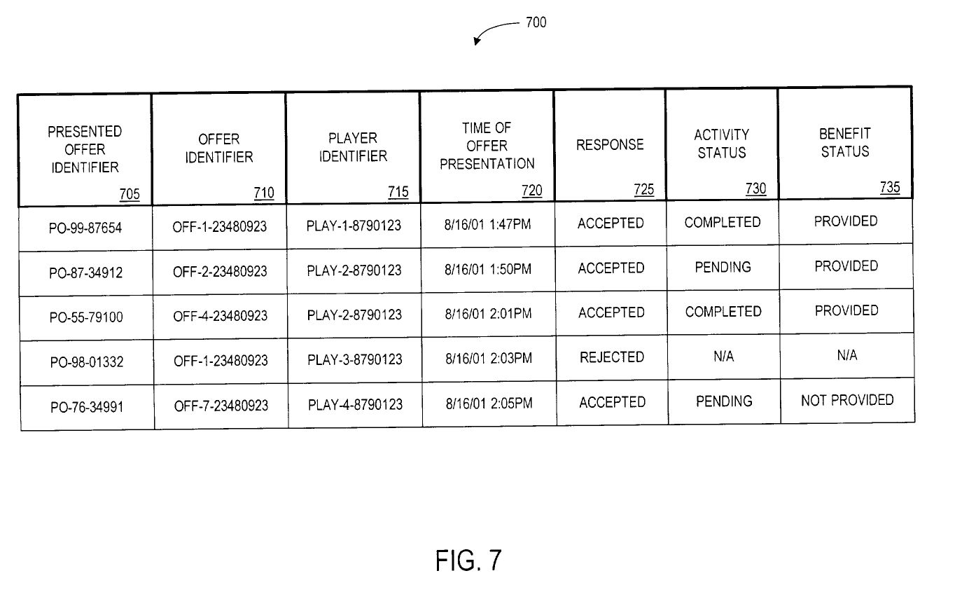

Referring now to FIG. 7, a tabular representation 700 of the offer tracking database 255 includes a number of example records or entries. Each of the records defines an offer that has been presented to a player. Those skilled in the art will understand that the offer tracking database may include any number of entries.

The tabular representation 700 also defines fields for each of the entries or records. The fields specify: (i) a presented offer identifier 705 that uniquely identifies an offer that has been presented to a player; (ii) an offer identifier 710 (corresponding to an offer identifier of the offer database tabular representation 600 of FIG. 6) which describes the offer that has been made, and thus the corresponding one or more activities and one or more benefits; (iii) a player identifier 715 that uniquely identifies the player to whom an offer had been presented; (iv) a time of offer presentation 715 that indicates the time at which the corresponding offer had been presented to the player; (v) a response 720 that indicates a response of the player to the offer that had been presented; (vi) an activity status 725 that indicates the status of the activity defined by the corresponding offer (e.g., whether the activity corresponding to the offer has been performed); and (vii) a benefit status 735 that indicates whether the benefit corresponding to the offer has been provided.

A record of the offer tracking database may be created, for example, when an offer is first output to a player. Data that is stored in a record of the offer tracking database may be received from, for example, a server computer of a gaming Web site (e.g., the central computer 105). For example, an indication of whether a player accepted or rejected an offer and/or an indication of whether a benefit was provided to the player may be transmitted from such a server computer. In some embodiments the offer tracking database is maintained on the same computing device as the gaming Web site is. In such embodiments this computer would simply store an indication of the player's response to an offer and an indication of whether a benefit has been provided to the player as the computing device itself determines this information. Data that is stored in a record of the offer tracking database may also be received from, for example, a subsidizer device. For example, a subsidizer device may transmit an indication of whether a player has completed an activity defined by the offer the player accepted and/or an indication of whether a benefit has been provided to the player (in embodiments where the subsidizer provides at least a portion of a benefit directly to a player).

Note that, in some embodiments, the player performs an activity defined by an offer at substantially the same time the player accepts the offer. For example, an activity defined by an offer may be answering a survey, wherein the survey form is an online questionnaire provided to the player along with the offer. In this example, the player may answer the survey and provide the answers when indicating an acceptance of the offer. In another example, an activity defined by an offer may comprise signing up for a service such as a subscription to a magazine. In this example, the player may provide a payment identifier (e.g., a credit card account number) when accepting the offer and the credit card may be charged for a cost associated with the service or the service provider may be notified of the player's agreement to sign up for the service at substantially the time the player is accepting the offer. The player, in this example, is thus committed to the activity and performs the activity at the time the player accepts the offer.

Exemplary Gaming Web Site

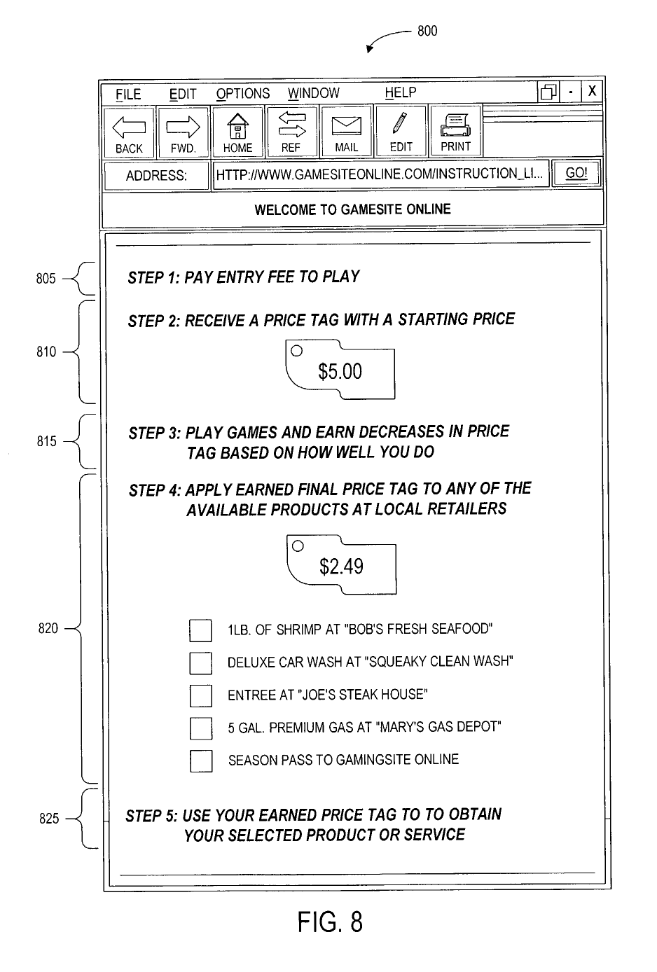

Referring now to FIG. 8, an exemplary Web page 800 illustrates a set of instructions for winning prizes (e.g., discounts on products and/or reductions of prices depicted on price tags) on an exemplary gaming Web site, in order to illustrate uses for offers on a gaming Web site in accordance with some embodiments of the present invention. The following description will discuss exemplary times for presenting an offer to a player during the process of winning a prize on the exemplary gaming Web site of Web page 800. It should be understood that an offer in accordance with the present invention may be presented at times other than those discussed with respect to FIG. 8 (e.g., offers may be emailed to a player before or after a player visits a gaming Web site). The times for presenting an offer discussed with respect to FIG. 8 are presented for illustrative purposes only and should not be construed as limiting in any manner.

The Web page 800 depicts a set of steps 1-5 for winning a prize on an exemplary gaming Web site. The steps are each illustrated in an area of the Web page: step 1 is illustrated in area 805, step 2 is illustrated in area 810, step 3 is illustrated in area 815, step 4 is illustrated in area 820, and step 5 is illustrated in area 825. In this example of a gaming Web site, a player is provided with one or more virtual price tags that each represent a price. The player may apply the price tag(s) to one or more products or services in a list of available products or services and thus purchase the one or more products or services for the price depicted on the price tag. The player plays games on the exemplary gaming Web site in order to lower the price depicted on the price tag, thus lowering the amount the player is to pay for the one or more products or services. The products or services may comprise, for example, products or services from merchants located within a particular community. For example, the merchants may comprise merchants within the player's geographical community (referred to herein as “local merchants”). In some embodiments, the merchants may comprise online merchants that operate Web sites through which products and services may be purchased.

As depicted in area 805, the first step in winning a prize on the exemplary gaming Web site is payment of an entry fee. Thus, in the gaming Web site of Web page 800 a player pays an entry fee before being permitted to win a prize. Accordingly, an offer in accordance with the present invention may be presented to a player as the player is prompted to pay an entry fee, as the player is paying the entry fee (e.g., as the player is inputting a payment identifier into the Web site), and/or after the player has paid the entry fee. The benefit defined by such an offer may comprise a waiver or refund of the entry fee. In one embodiment a player may be presented with an offer that defines one or more free passes for playing on the gaming Web site as a benefit (e.g., the offer could be provided to the player as the player is viewing instructions on how to play on the gaming Web site or as the player is visiting another Web site).

Referring now to area 810, the second step of winning a prize on the exemplary gaming Web site of Web page 800 is being provided with one or more virtual price tags that each represent a starting price. Web page 800 illustrates an exemplary price tag representing an exemplary starting price of $5.00. An offer in accordance with the present invention may be presented to a player during this second step. Such an offer may define a benefit, for example, of a lower starting price for a price tag provided to the player during this second step. For example, an offer may define that the starting price of the price tag provided to the player will be set to $3.00 rather than $5.00 if the player agrees to a free trial membership to an online buying club. Another example of a benefit that may be included in an offer presented to a player during step 1 is an increase in the number of price tags the player is starting with.

Referring now to area 815, the third step of winning a prize on the exemplary gaming Web site of Web page 800 comprises playing games in order to earn a reduction in the value of one or more price tags provided to the customer in step 2. One or more offers in accordance with some embodiments of the present invention may be presented to the player while the player is playing such games. For example, if the player obtains a non-winning outcome during a game (e.g., and consequently does not earn any reduction in the price depicted on the one or more price tags), the player may be presented with an offer that defines a benefit, for example, of providing a winning outcome to the player. For example, the player may be provided with an offer that offers to change the player's outcome in a game from a non-winning outcome to a winning outcome if the player answers some survey questions (the survey questions comprising the activity defined by the offer). Alternatively, the offer may define a benefit of a reduction in the price depicted on the player's price tag even though the player did not earn a winning outcome in a game, without necessarily changing the outcome of the game for the player. In yet another example, the offer may define a benefit of allowing the player to replay the game or a portion of the game (effectively providing the player with a second chance at earning a winning outcome). Another example of a benefit comprises a hint or clue in playing a game. For example, a second hint towards an answer in a trivia game, e.g., if more than a predetermined amount of time has passed since the player was presented with a first hint.

Note that an offer similar to the ones just described may be provided to a player even if the player did achieve a winning outcome in a game (i.e., the offer need not only be presented if the player obtains a non-winning outcome in a game). For example, an offer may be presented to a player wherein the defined benefit comprises a more favorable outcome than the one obtained by the player or a further reduction in the price depicted by the price tag in addition to the reduction earned by the player during the game play.

Referring now to area 820, the fourth step of winning a prize on the exemplary gaming Web site of Web page 800 comprises selection, by the player, of at least one product and/or service to which the player desires to apply the price tag. In other words, the player selects which at least one product or service the player desires to purchase for the price depicted by the price tag. There are various opportunities for presenting offers in accordance with embodiments of the present invention to a player during this fourth step. For example, an offer may define a benefit of yet a further reduction in the price depicted by the price tag. In another example, an offer may define a benefit of an additional price tag depicting the same price, an increase in the quality (perceived or actual) of a product or service to which the player applied a price tag (e.g., a six-pack of soda may be changed to a 12-pack of soda, for the same price) and/or allowing the player to apply the price tag to more than one product or service (assuming that, before the offer, the player was only allowed to apply one price tag per product or service). In another example, an offer may comprise a benefit of access to an additional product or service to which the player may apply the price tag to (i.e., in addition to those displayed as available to the player before the offer). Such an additional product or service may be, for example, associated with a higher retail price than the products and services available to the player before the offer.

For example, in some embodiments of the exemplary Web site described herein, different types of price tags may be available. Each type of price tag may be associated with a different characteristic (e.g., with a specific group of merchants, with a specific set of products or services to which the price tag may be applied, and/or with a specific starting price). In such embodiments, the list of products and services displayed to a player in step 4 as being available for application of the price tag may be based on which type of price tag was provided to the player in step 1. In such embodiments, an offer provided to the player during step 4 of winning a prize may define a benefit of making one or more products or services available to the player that are not otherwise associated with the type of price tag that was provided to the player in step 1.

For example, assume that a first type of price tag has a starting price of $5.00 and is associated with (i.e., may be applied to, in step 4,) a product or service in a set of products or services whose individual retail price is in the range of $7.50 and $15.00. Further assume that a second type of price tag has a starting price of $20.00 and is associated with a set of products and services whose individual retail price is within the range of $20.00 and $35.00. A player may be provided with a price tag of the first type during the first step of winning a prize. Subsequently, during the fourth step of winning a prize, the player may be presented with the set of associated products and services to which a price tag of the first type may be applied. Accordingly, an offer may be presented to the player that defines a benefit of allowing the player to apply the price tag of the first type to at least one product or service that is associated with the second type of price tag. Note that an offer defining such a benefit may be presented to a player at other times (e.g., during step 1). This is true for all the offers described herein. An offer that is described as being presented to a player at a particular time may be presented to a player at another time that is also appropriate.

Note that the products and services displayed to a player as products and services to which the player may apply his price tag during step 4 may be selected for display to the player based on the retail price of the product or service (i.e., the shelf price for the product or service a conventional customer would pay). The products and services may also be selected for display based on a cost of the products or services to the gaming Web site operator or other entity through which the player may purchase the products. This may be particularly useful in embodiments where the player purchases the product(s) or service(s) from the gaming Web site using his price tag(s) and subsequently takes possession of the product(s) or service(s) at the merchant while the gaming Web site operator pays the merchant(s) a predetermined price that is not necessarily the price depicted on the price tag(s) the player used. Commonly-owned, co-pending U.S. patent application Ser. No. 09/348,566 (filed Jul. 7, 1999) discloses various methods for settlement of funds based on a transaction wherein a player purchases a product online from a first entity and takes possession of the product or service at a second entity. The entirety of this application is incorporated by reference herein for all purposes.

The products and services displayed to the player in step 4 may also be selected for display based on one or more of (i) a geographical location of the player, (ii) a popularity of the product or service with this player or other players; and (iii) another factor determined to be relevant by one or more of the gaming Web site operator, the merchant associated with the particular product or service, and a subsidizer.

Note that, in some embodiments, a gaming Web site operator or other entity operating central computer 105 may allow merchants to enter products and services into the memory of central computer 105. For example, the gaming Web site operator or other entity operating central computer 105 may provide merchants access to a Web page via which the merchants may indicate which products and/or services are available to players of the gaming Web site. For example, a local merchant may wish to promote a particular service and thus enter a description of the service into a database of available products and services of the central computer 105 (e.g., for presentation to players during step 4 of the process of winning a prize in the exemplary gaming Web site of Web page 800). The merchants, in such embodiments, may further indicate when, how, and/or to whom particular products or services are to be made available. For example, a merchant may specify that a particular product is only to be displayed to players associated with a particular characteristic (e.g., who fit a particular demographic profile) or to players who are applying a price tag of a certain type (e.g., a price tag whose starting price was not less than a predetermined amount and/or whose final price is not less than a predetermined amount). The latter condition may be to prevent brand-name dilution (e.g., to prevent a perception of low quality of a product or service that may be fostered by too low of a price being charged for the product or service).

Referring now to area 825, the fifth step of winning a prize on the exemplary gaming Web site of Web page 800 comprises obtainment, by the player, of the product and/or service selected in step 4. The player may obtain the product or service by, for example, visiting a brick-and-mortar store of the merchant who provides the product or service. Commonly-owned, co-pending U.S. application Ser. No. 09/337,906 (filed Jun. 22, 1999) describes various systems and methods wherein a player purchases a product or service online from a first entity and takes possession of the product or service at a brick-and-mortar store operated by a second entity. The entirety of this application is incorporated by reference herein for all purposes. In another example, the player may obtain the product by, for example, visiting a Web site of an online merchant that provides the product or service. This step provides various opportunities for presentation of an offer in accordance with embodiments of the present invention to the player.

For example, in one embodiment, the player may print out a coupon, voucher, or other documentation for presentation to the merchant when obtaining the product or service. An offer in accordance with the present invention may be printed on such documentation. The player may accept the offer on the voucher and, for example, indicate his acceptance to the merchant.

In one embodiment, the player may provide a payment via a credit or debit card at the merchant when obtaining the product or service selected by the player in step 4. In such an embodiment, an offer in accordance with the present invention may be presented to the player at the merchant (e.g., via a point-of-sale or other terminal at a brick-and-mortar merchant or via a Web site of an online merchant).

An offer presented to a player during step 5 of winning a prize on an exemplary Web site of the Web page 800 may define, for example, a benefit of an upgrade in the product or service the player selected in step 4 (e.g., an upgrade from a regular car wash to a deluxe car wash, if the merchant is a car wash operator) or an increase in the number of units of the product or an increase in the number of provisions of the service. In such an embodiment, the subsidizer may also be the merchant that provides the product or service. For example, an offer may define an activity of committing to make a predetermined number of purchases or purchases with a predetermined frequency from the merchant.

Methods

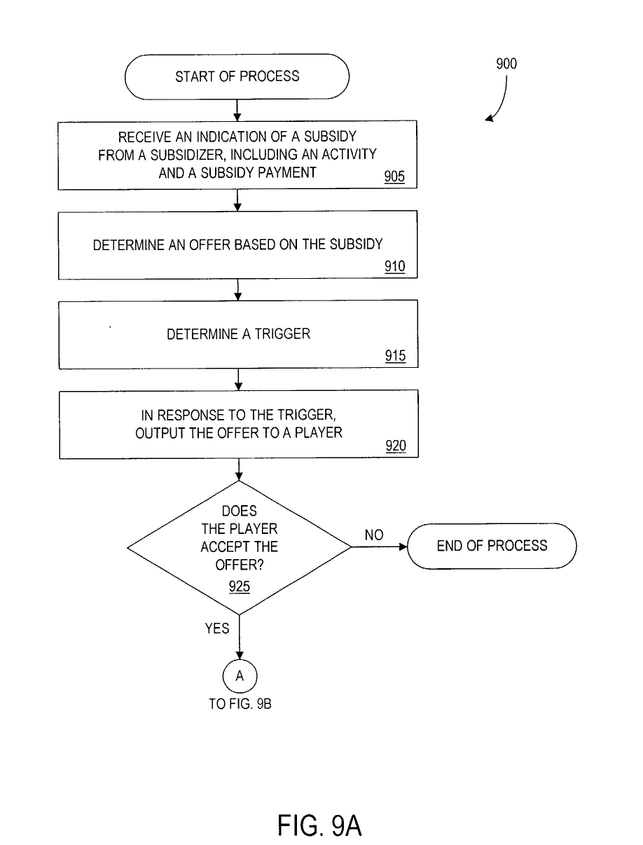

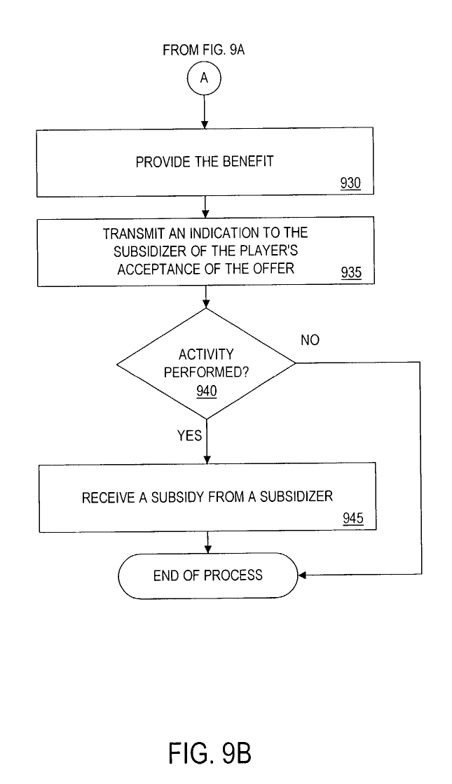

Referring now to FIG. 9A and FIG. 9B, a flow chart of a process 900, in accordance with an embodiment of the present invention, is illustrated. Process 900 may be performed by, for example, the central computer 105, another computing device operating in accordance with the present invention, or a combination thereof. The particular arrangement of elements in the flow chart of FIG. 9A and FIG. 9B is not meant to imply a fixed order to the steps; embodiments of the present invention can be practiced in any order that is practicable.

In step 905 an indication of a subsidy is received from a subsidizer. The indication of the subsidy includes an indication of an activity. Accordingly, in one embodiment a subsidizer may specify an activity to be performed and a subsidy to be provided but not necessarily the benefit to be provided in exchange for a commitment to the activity. The subsidy may be provided, for example, to the operator of the central computer 105, a gaming Web site operator (if different from the operator of the central computer), to the player who eventually accepts an offer defining the activity, and/or a merchant. The indication of the subsidy received in step 905 may be stored (e.g., in a subsidy database, such as illustrated by tabular representation 300). Note that the indication of the subsidy may be received by various means, including electronically (e.g., the subsidizer may fill out an electronic form on a Web site or transmit an e-mail), via postal mail, or verbally (e.g., during an in-person or telephone conversation with an employee of the operator of the central computer).

In step 910, an offer is determined based on the indication of the subsidy received in step 905. Step 910 may comprise, for example, determining a benefit to be provided to a customer in exchange for the player's commitment to the activity specified in the indication of the subsidy. The benefit may be selected, for example, based on (i) a monetary value of the subsidy, (ii) the activity, or (iii) a combination thereof.

Determining a benefit to include in the offer based on the activity may comprise, for example, determining one or more of (i) a difficulty of the activity, (ii) a time for completing the activity (e.g., a predicted or expected time or a time based on historical performance of the activity by players), (iii) an amount of effort (e.g., perceived, predicted, or as expressed by other players who have completed the activity) required to complete the activity, and/or (iv) a perceived burden of committing to the activity. The benefit may thus be selected such that, as perceived by the player who is to be presented with the offer defining the activity and the benefit, the value (monetary or non-monetary) of the benefit is at least equal to the cost (e.g., monetary or non-monetary) of committing to the activity.

In one embodiment, for example, a monetary value may be placed on the activity (e.g., a cost that a player may associate with the activity based on, for example, the amount of time or perceived effort for completing the activity) and a monetary value may be placed on each of a set of potential benefits that may be paired with the activity in an offer. In this example one of the benefits may be selected from the set of benefits such that the monetary value of the benefit is at least equal to the monetary value of the activity.

Note that the benefit may be selected by the operator of the gaming Web site, the operator of the central computer 105 (if different from the operator of the gaming Web site), a merchant, the subsidizer who submitted an indication of the subsidy corresponding to the activity to which the benefit is to be paired, another party (e.g., a consultant), a player (e.g., the player to whom the offer that defines the benefit is to be presented), and/or a combination thereof.

The step of determining an offer based on the activity (step 910) may be performed (i) when the indication of a subsidy is received (and stored for subsequent use thereafter); (ii) when a benefit is determined (e.g., received into a system of the present invention as a benefit that is available for provision to one or more players); (iii) when it is determined that an offer should be output to a player; (iv) on a periodic basis (e.g., once a week each of the activities corresponding to a subsidy that has been received since the last time this process was performed is paired with at least one benefit and at least one offer created); or (v) another time. Note that more than one offer may be determined based on a single subsidy (e.g., more than one benefit may be paired with an activity, each pairing constituting a different offer).

Note that an offer may be determined based on the subsidy such that the offer results in a profit for the operator of the central computer 105 or the operator of the gaming Web site (if different). For example, an offer may be determined such that the value of the subsidy exceeds any cost that may be incurred as a result of providing the benefit to the player.

Note that an offer may be determined based on a characteristic of a player. For example, an offer may be determined (e.g., an activity and/or a benefit may be selected) based on information associated with the player to whom the offer is to be presented. An offer may be selected, for example, such that the activity defined by the offer is appropriate for the player (e.g., is likely to be accepted by the player and/or is likely to particularly benefit the subsidizer associated with the activity) based on information known about the player. For example, if it is known that a player drives an older vehicle that the player may be considering replacing (e.g., tabular representation 400, in the notes field 430, indicates that player “Mike Green” drives a 1983 Toyota™ Tercel™), an offer that defines an activity of test driving a new car, visiting a car dealer, or answering survey questions regarding new models of cars may be selected.

An offer may also be selected based on a benefit that is appropriate (e.g., is likely to motivate the player to accept the offer and/or is particularly likely to benefit the gaming Web site operator) based on information known about the player to whom the offer is to be presented. For example, if it is known that a player has not won a prize of a particular value (e.g., based on tracking the player's results in previous game play), an offer that defines a benefit of a prize upgrade to a prize of the particular value may be selected. Such a benefit is both likely to motivate a player to accept the offer and particularly benefit the gaming Web site operator since it may alleviate any discouragement the player may have previously felt about continuing to play on the gaming Web site.

Examples of characteristics of a player that may be utilized in determining an offer include, but are not limited to, (i) demographic information about the player (e.g., the player's birthday); (ii) the player's hobbies and interests (e.g., sailing, golf); (iii) any information stored in the player database (e.g., such as the one illustrated in tabular representation 400); (iv) physical characteristics of the player (e.g., age, height, weight, gender, dress and appearance); (v) the player's occupation, income, work hours, credit report, home town, marital status; (vi) the player's medical history; (vii) friends of the player; and (viii) the player's gaming history. Examples of factors relating to the player's gaming history include, but are not limited to, (i) games that have been played by the player; (ii) results of games participated in by the player; (iii) prizes won by the player; (iv) strategies and other patterns of game play practiced by the player; (v) the player's success in playing games relative to one or more other players (e.g., is the player one of the 100 best at ScrabbleTM?); and (vi) times when the player plays games (e.g., times of the day, week, month, year).

In one embodiment, an offer is determined based on at least one factor relating to the player's purchasing history (e.g., with the gaming Web site or with another entity). Examples of factors relating to a player's purchasing history include, but are not limited to, (i) which products/prizes the player has purchased (e.g., in which combinations); (ii) entry fees paid by the player; (iii) what form of payment the player uses (e.g., Visa™, Mastercard™, Discover™); and (iv) trends that may be useful in predicting future purchases of the player. According to one embodiment, information about a player's purchasing history is stored in a player database (e.g., such as the one illustrated in tabular representation 400).

An offer may be determined based on a characteristic of one or more players other than the player to whom the offer is to be presented. Note that, in one embodiment, an offer is determined before a player to whom it is to be presented is identified. For example, an offer may be determined based on historical acceptance rates and/or feedback from other players. For example, it may be determined that a particular benefit does not motivate many players (or does not motivate many players who fit a particular demographic profile). Thus, an offer may be determined based on the subsidy by pairing the activity corresponding to the subsidy with a benefit that is a benefit that has had a favorable response from past players.

An offer may be determined based on one or more factors relating to at least one offer. Examples of such factors include, but are not limited to (i) whether the player completes an activity specified by a previous offer; (ii) the inventory of offers (e.g., in an embodiment where only a limited number of offers may be presented); (iii) offers that have already been made to the player to whom the subject offer is to be output; (iv) offers that the player has accepted or rejected (e.g., as stored in an offer tracking database, such as the one illustrated in tabular representation 700); (v) offers that have been made to other players (e.g., as stored in an offer tracking database such as the one illustrated in tabular representation 700); (vi) the activity to be performed by the player and/or how well the player performs the activity (e.g., the benefit may not be determined until after the player completes the activity); (v) the benefit to be provided in an offer (e.g., the player may be allowed to select what benefit he would like to earn and the central computer 105 may determine what activity the player should perform to earn this benefit); (vi) whether the player is suitable for a particular type of offer (e.g., if the offer is for a new credit card, what is the player's credit limit? If the offer is for a magazine subscription, does the player already receive the magazine?); (vii) factors that affect performing an activity (e.g., if the network connection between the central computer 105 and the player is slow, then an activity may be selected that does not require very much, if any, bandwidth); (viii) factors that affect the value of an activity (e.g., information about player buying habits may be more valuable two weeks before a big sale than the day after a big sale); (ix) activities in progress (e.g., only one player at a time may be able to talk with a customer service representative); and (x) anticipated future activities (e.g., other players waiting in line to perform activities).

Note that an offer may not be determined for every player at a gaming Web site. For some players, the central computer 105 may determine not to output an offer. Reasons for this include, for example, determining that (i) a player has already received an offer in the past and the gaming Web site operator desiring to avoid making duplicate offers; (ii) a player has been banned from receiving offers (e.g., because he did not perform an activity as required); and (iii) if offers are output less often, then players may view them as being more special (which may in turn result in players paying more attention to offers and accepting more offers).

An offer may be determined using a variety of methods. In one embodiment, an offer may be determined using a rules-based system. In such a system the central computer 105 or another computing device may determine an offer according to a set of rules defined using Boolean expressions. In one embodiment, an offer may be determined using a pseudo-random system. For example, the central computer 105 or another computing device may randomly select an activity from a list of available activities and randomly select a benefit from a list of available benefits in order to determine an offer. In one embodiment, a player may be allowed to create or choose his own offer. For example, a player may be allowed to select an activity from a list of available activities and select a benefit from a list of available benefits, thus creating an offer. Note that, in one embodiment, a benefit may be selected using a first method and an activity may be selected using a second, different, method.

In step 915 a trigger is determined. Determining a trigger may comprise, for example, determining that a trigger event has occurred. For example, the central computer 105 may monitor game play by each player on the gaming Web site (e.g., on a continuous basis) to determine whether one of the trigger events described in a trigger database (such as the one illustrated by tabular representation 500) has occurred. Alternatively, step 915 may comprise receiving an indication of an occurrence of a trigger event from another computing device that has identified the occurrence (e.g., a player device 115).

Note that, in some embodiments, the benefit to be paired with an activity in determining an offer may be selected or determined based on the trigger. In such embodiments, a benefit is determined (and thus an offer is determined) once the occurrence of a trigger has been identified. Accordingly, in some embodiments the step of determining an offer (step 910) may occur after or as the trigger is determined in step 915.

In step 920 an offer is output to the player based on whose game play the trigger event has been identified. Outputting the offer to the player may comprise, for example, causing a message describing the offer to be output on a screen or microphone of a player device 15.

According to one embodiment, presenting an offer to a player comprises presenting the activity to be performed, and presenting the benefit to be received. It is understood that presenting an offer to a player may comprise two or more separate processes. For example, an activity could be presented to a player in one way (e.g., an audio message), and a benefit could be presented to a player in a different way (e.g., via a graphical animation).

In one embodiment, an offer is presented to a player soon after a trigger is determined. For example, an offer may be presented to a player in response to an indication from the player that he would like to pay an entry fee to play games on the gaming Web site (one example of a trigger). In response to the player's indication, the central computer 105 or another computing device may present an offer to the player that defines a benefit of a discount on the entry fee. In another example, the occurrence of a player winning a prize in a game (another example of a trigger) may cause an offer to be presented to the player in conjunction with an indication that the player has won a prize. In yet another example, receiving an indication that a player would like to purchase a product using a form of currency won while playing one or more games on the gaming Web site (yet another example of a trigger), may cause the central computer 105 or another computing device to cause an offer to be presented to the player. In such an example, the offer may define a benefit of, for example, a discount of the amount of currency necessary to purchase the product and an activity of signing up for a magazine subscription.

Note that outputting an offer to a player may comprise outputting the offer at a time other than when a player is visiting a gaming Web site. For example, an offer may be mailed to a player using electronic mail and/or postal mail. In another example, an employee of the gaming Web site or another entity (e.g., an employee of a subsidizer) may telephone a player and present the offer to the player verbally.

According to one embodiment, the central computer 105 may present an offer to a player by transmitting the offer through a communication network (e.g., the Internet) to a player device 115 operated by the player (e.g., a personal computer). The player device 115 may then display the offer to the player using an output device (e.g., a CRT monitor). Other examples of manners of presenting an offer to a player include: (i) causing a player's Web browser to display a Web page that includes one or more offers (e.g., the player may select an offer that he would like to accept); (ii) causing (e.g., in between rounds of a video game) a player's Web browser to display a pop-up window that displays information about an offer; and (iii) causing a message describing an offer to be sent to a player's e-mail account (e.g., when the player reads his email, the message is displayed, along with a hyperlink to a web page that the player may access to accept the offer).

According to one embodiment, an offer may be presented to a player by an employee of an entity (e.g., an employee of a party operating the central computer 105). In such an embodiment, a device associated with the central computer 105 may be used to prompt the employee to present the offer to the player. For example, the central computer 105 may use a CRT monitor to display an offer to a call center employee. The call center employee may then use a telephone to call a player and present the offer to the player.

According to one embodiment, an offer may be presented to a player as part of a game. For example, a character in a game may speak to the player and make him an offer. For example, a parrot in a treasure hunt game may offer a player 500 points if he signs up for a trial subscription to Scuba Diving magazine. In another example, a player playing the game Breakout™ may be presented with an offer by the offer being displayed on one or more blocks in the game. If the player hits a block containing an offer, then the player may receive the offer. Alternatively, hitting a block containing an offer may constitute acceptance of the offer. In yet another example, in the game Tetris™ an offer may be associated with a falling block in the game. The offer may say, for example, “If you use this block to complete a line, then you will receive an offer.”Alternatively, the offer displayed on the block may convey to the player an indication of a benefit the player is to receive if he uses the block and/or an indication of the activity the player must commit to (other than using the block within the game) in order to obtain the benefit. In yet another example of an offer being presented to a player as part of a game, benefit to be received may be displayed in the background behind a crossword puzzle or on an area of a reel of a virtual slot machine.

According to one embodiment, a player may be reminded of an offer that was previously output to the player or that the player accepted while the player is performing an activity (e.g., the activity defined by an offer the player previously accepted). For example, a pop-up window may be caused to be displayed by a Web browser, the pop-up window displaying a message that indicates to the player how many more games he has to complete before he earns a free magazine subscription. In another example, an animated character in a game may remind the player that if he signs up for a new credit card, then his avatar in the video game will automatically gain 500 stamina points.

According to one embodiment, a player may perform an activity to earn a benefit for a friend. In this embodiment, knowing that his friend is aware of an offer may provide additional motivation for a player to complete an activity defined by an offer. Therefore, the central computer 105 or another computing device may send an indication of an offer (e.g., an offer accepted by the player) to at least one friend of a player. For example, the central computer 105 may send an e-mail message to a friend indicating, “Your friend John has the opportunity to win 30 tokens for you by signing up for a new credit card.” In another example, the central computer 105 or another computing device may prompt an employee to telephone a player's friend and tell him that the player is attempting to earn a prize for the friend.

Note that either step 915 or step 920 may include a step of determining which offer (e.g., from a plurality of available offers stored in memory) to present to the player or creating an offer to present to the player. For example, in one embodiment one or more offers may correspond to each trigger in a trigger database. In such an embodiment, the central computer 105 or other device performing a step of the process 900 may access a trigger database (such as the one illustrated in tabular representation 500) and determine which offer(s) correspond to the trigger event that was determined to have occurred in step 915. In such an embodiment if more than one offer corresponds to the trigger event the central computer 105 or other computing device may select a subset of the offers (e.g., a single offer) for presentation to the player. In one embodiment, more than one offer may be presented to the player and the player may be allowed to select which offer(s) the player accepts.

Referring again to FIG. 9A, step 925 comprises determining whether the player has accepted the offer that was output in step 920. If the player has rejected the output offer, the process 900 ends. Alternatively, another offer may be output to the player or a dialogue initiated with the player in order to determine, for example, why the player did not accept the offer and/or how the offer may be modified in order to for the player to be willing to accept it. If, in step 925, it is determined that the player has accepted the output offer the process 900 continues to step 930.

According to one embodiment, a player may respond to an offer by accepting or rejecting it. An acceptance of an offer by a player comprises a commitment by the player to perform the activity defined by the offer in order to receive the benefit defined by the offer.

According to one embodiment, a player may indicate his acceptance of an offer using an input device (e.g., a mouse) associated with a player device 115 (e.g., a personal computer). The player device 115 may then transmit the indication of the player's acceptance to the central computer 105 using a communication network (e.g., the Internet).

According to one embodiment, a player may accept an offer by performing an action in a game. For example, an offer may be associated with a particular representation of a playing card in a video poker game. Selecting the card (e.g., as a card to hold, a card to be discarded, or a replacement card) may comprise an acceptance of the offer. In another example, a character in a video game (e.g., Ultima™) may present an offer to the player. If the player uses his avatar to shake hands with the character (e.g., sealing the deal), this may constitute acceptance of the offer. In yet another example, offers may be associated with various selectable options in a game and the player may indicate acceptance of an offer by selecting a particular option associated with that offer. For example, a plurality of doors in a maze may each be associated with an offer. If the player opens the first door, he accepts a first offer. If the player opens the second door, then he accepts a second offer. If the player opens the third door, then he rejects both of the offers.

According to one embodiment, an indication of whether a player accepted or rejected an offer may be stored in an offer tracking database, such as the one illustrated in tabular representation 700. Other information regarding an offer presented to a player (e.g., whether the benefit was provided to the player) may also be stored in such a database, as described herein.

According to one embodiment, a player may provide information when accepting an offer. For example, a player may identify himself in some way (e.g., by providing a username, a home telephone number, an address, a driver's license number) when accepting an offer. This identification information may be useful in determining which player accepted an offer. This identification information may also be stored in an offer tracking database (such as the one illustrated in tabular representation 700) or a player database (such as the one illustrated in tabular representation 400).

Another type of information a player may provide when accepting an offer is a payment identifier (e.g., a credit card number). A payment identifier may be useful, for example, in enabling or securing a player's performance of one or more activities. For example, if a player makes a forward commitment to perform an activity, then his payment identifier may be used to penalty-secure this forward commitment. According to one embodiment, a payment identifier provided by a player may be stored in a player database, such as the one illustrated in tabular representation 400.

A player may perform an activity when accepting an offer (e.g., as an indication of acceptance or at substantially the same time as providing the acceptance). For example, a player may receive an offer to perform an activity of answering survey questions online. In this case, the player may provide answers to the survey questions when accepting the offer. Receiving the answers may, for example, comprise receiving an indication of offer acceptance without any additional indication of offer acceptance by the player.

Once it is determined, in step 925, that the player has accepted the offer, the benefit is provided (e.g., to the player or another person) in step 930. According to one embodiment, a benefit may be provided to a player immediately after he accepts the offer defining the benefit. This embodiment may be particularly appealing to players because it allows them to obtain immediate gratification for accepting an offer. Accordingly, such an embodiment may result in a particularly high acceptance of offers because players may be particularly motivated to receive certain benefits (e.g., an upgrade in a prize or extra points added to their score). Alternatively, a benefit may be provided at a time other than a time when a player accepts an offer (e.g., after a player performs the activity defined in the offer), as described above.

In one embodiment, a benefit may be provided to a player by the central computer 105 or the operator of the gaming Web site (if different from the entity operating the central computer). In another embodiment, a benefit or a portion of a benefit may be provided to the player by a subsidizer, a merchant, or another entity. In embodiments where an entity other than the entity to whom the player provides an indication of acceptance of the offer provides the benefit, step 930 may comprise informing the entity that is to provide the benefit of the offer acceptance.

In one embodiment, the central computer 105 in step 930 may determine that no benefit should be provided to a player at the current time. This could happen for a variety of reasons, including: (i) an activity was not performed; (ii) an activity was performed in an unsatisfactory manner; and (iii) an activity was not completed.

In step 935, an indication of the player's acceptance of the offer is transmitted to the subsidizer associated with the activity defined by the offer. According to one embodiment, the central computer 105 or another computing device may transmit information to at least one subsidizer associated with an offer. According to one embodiment, this information may be received by a subsidizer device 110. The subsidizer device may in turn store this information in a database or other memory. The subsidizer may then use this information to track a player's performance of an activity specified in the offer. In one embodiment, the gaming Web site tracks the player's performance of the activity defined by the offer and transmits the indication of the player's acceptance of the offer to the subsidizer for purposes of billing and/or auditing. For example, in embodiments where the subsidizer pays the subsidy payment each time a customer accepts an offer defining an activity of the subsidizer, the subsidizer may wish to be notified when a player accepts an offer. A subsidizer may also desire to know when a player accepts an offer defining an activity of the subsidizer in order to contact the player directly (e.g., to market other products or services to the player).

In one embodiment, the central computer 105 or other computing device may transmit information about the player to at least one subsidizer. For example, the central computer 105 may transmit an indication of the player's name and home address to the subsidizer.

In one embodiment, the central computer 105 or other computing device may transmit an indication of a payment identifier to the at least one subsidizer. As described above, a payment identifier provided by a player may be useful in ensuring that the player performs an activity specified in an offer (e.g., following through on a forward commitment to perform an activity, purchasing a product).

Transmitting a player's payment identifier to a subsidizer is particularly appropriate for embodiments of the invention in which the subsidizer tracks or enables a player's performance of an activity specified in an offer. Allowing a subsidizer to track or enable the performance of an activity by a player may be desirable for a number of reasons. For example, it may simplify accounting performed by the central computer 105 or the subsidizer. It may also reduce the amount of work performed by the central computer 105, thereby making it easier or less costly to implement the central computer 105. It may also help to clarify to the player that he is performing an activity for the subsidizer, not for the central computer 105 or the gaming Web site. Lastly, it may allow the subsidizer to establish a relationship with the player, which may be helpful in enabling future transactions between the two parties.

According to one embodiment, either the central computer 105 or a subsidizer may verify the authenticity of a payment identifier (e.g., using a credit card authorization network). This may be helpful to prevent customers from utilizing false or inactive payment identifiers.

According to one embodiment, a player may have agreed to perform an activity of purchasing a product from a subsidizer. In such an embodiment, the subsidizer may charge the player's payment identifier for the cost of the product.

Note that it is also possible for the central computer 105 to charge the player's payment identifier for the product and then pay this amount to the subsidizer. However, this embodiment may be not be desirable to certain entities because it requires an additional accounting by the central computer 105 and the subsidizer, and it may be unclear to a player where he purchased the product.

According to one embodiment, a player may have made a forward commitment to perform an activity for a subsidizer. In this case, the subsidizer may store the player's payment identifier in a database or other memory. If the player performs the activity as he agreed to, then a penalty may not be charged to a financial account corresponding to the financial identifier. However, if the player does not perform the activity as defined by the offer, then the subsidizer may use the player's payment identifier to levy a penalty against the player.

In step 940, it is determined whether the player performed the activity defined by the offer accepted by the player. This step may comprise, for example, communicating with another computing device (e.g., a point-of-sale server of a merchant, a subsidizer device, or a computing device operated by an entity involved in the player's performance of the activity). For example, the central computer 105 may receive a signal from another computing device, indicating that a player has performed an activity. Alternatively, the central computer 105 may query another computing device to determine whether a customer has performed an activity.

In one embodiment, the player provides proof of having performed an activity. For example, the player may be required to provide a code to the central computer 105 (e.g., within a predetermined time of having accepted the offer defining the activity). The player may obtain such a code, for example, when he performs the activity. For example, an activity may comprise visiting a merchant (whether online or a brick-and-mortar establishment) and obtaining a code from the merchant. In another example, an activity may comprise purchasing a product and/or service and the code to be provided to the central computer may comprise a proof-of-purchase bar code from the product or service. In yet another example, the activity may comprise calling a telephone number (e.g., an 800 number or a 900 number) and listening to a message (e.g., an advertisement) or answering survey questions. In such an example, the player may be provided with a code at the end of the message or at the end of answering such survey questions. The player may then provide the code to the central computer 105 or other computing device tracking the performance of the activity.

In one embodiment, an employee of an entity that determines the performance of an activity (e.g., a subsidizer or merchant) may access a Web site of the gaming Web site or other entity operating the central computer and enter an indication of the performance of the activity by the player. For example, the employee may access an offer tracking database (e.g., such as the one illustrated in tabular representation 700) and enter an indication of the performance of the activity therein.

An indication of the performance of an activity may be received over a communications network (e.g., the Internet or the public telephone exchange). For example, an indication of the performance of an activity may be received electronically (e.g., via an Internet Web site, an intranet, or an e-mail message), via a voice mail message or other telephonic communication, or via postal mail.

In step 945, a subsidy is received from a subsidizer. This subsidy may be based on a single offer of a single player or on a plurality of offers associated with a plurality of players. For example, a subsidy may be received from a subsidizer each time a player accepts an offer, qualifies for performing an activity or for receiving a benefit, and/or performs an activity defined by an offer. In another example, a subsidy may be received on a periodic basis and be based on the aggregate players who have accepted offers, qualified for activities or benefits, and/or performed activities defined by offers since a previous subsidy payment. In one embodiment, a subsidy is received from a subsidizer regardless of whether an offer corresponding to the activity of the subsidizer has been output to a player, accepted by a player, or fulfilled by the player. For example, in one embodiment a subsidizer provides a subsidy to the central computer 105 or other computing device operating in accordance with embodiments of the present invention when the subsidizer first provides an indication of the subsidy to the central computer 105 or other computing device.

Although specific embodiments and examples of the present invention have been described herein, it should be understood that the invention is not so limited and other embodiments and applications of the present invention would be understood by one of ordinary skill in the art after reading the description herein. For example, a single entity may participate in a system of the present invention as both a local merchant that provides products and services on a gaming Web site and as a subsidizer.

Note that, although certain embodiments have been described herein with reference to particular figures, such presentation is not meant to be limiting in any manner. An embodiment described herein is not limited to usage with any feature described in a figure with reference to which the embodiment is described. For example, certain embodiments of what a benefit may comprise are described with reference to the offer database of FIG. 6. However, such embodiments may be employed without necessarily implementing the offer database of FIG. 6, or any offer database.

What is claimed is:

1. A method comprising:
identifying a player on a gaming Web site;
determining the occurrence of an event on the gaming Web site that triggers the presentation, to the player, of at least one offer of a plurality of available offers to the player,
wherein each offer of the plurality of offers defines
a benefit that confers an advantage on the player in playing a game of the gaming Web site, and
an activity that, when performed by the player, results in a value being realized by a subsidizing entity that is funding the provision of the benefit to the player;
selecting which offer of the plurality of offers to present to the player by determining which offer corresponds to a description of the occurrence of the event in a database;
presenting the offer to the player by causing a remote player device being operated by the player to display the offer to the player;
receiving a response to the offer from the player;
providing the benefit to the player if the response indicates an acceptance;
storing an indication of the player's acceptance of the offer in memory;
determining whether the player has performed the activity defined by the offer;
receiving a subsidy from the subsidizing entity based on at least one of
the presentation of the offer to the player, and
the performance of the activity by the player; and
causing a penalty to be assessed to the player if the player has not performed the activity defined by the offer.

2. A method comprising:
determining that an event that triggers the presentation of an offer to a player of a gaming Web site has occurred on the gaming Web site;
determining the offer to present to the player, wherein the offer defines
a benefit; and
an activity that the player must commit to in order to be provided with the benefit;
presenting the offer to the player
determining that the player has accepted the offer;
providing the benefit to the player;
determining that the player has performed the activity; and
receiving a subsidy from a party subsidizing the benefit based on at least one of the presentation of the offer to the player, the player's acceptance of the offer, and the player's performance of the activity.

3. The method of claim 2, wherein the benefit comprises an advantage for the player in playing a game on the gaming Web site.

4. The method of claim 3, wherein the benefit comprises at least one of:
an increase in a score the player achieved while playing a game on the gaming Web site,
a replacement outcome that is more favorable than an outcome the player actually achieved while playing a game on the gaming Web site and that is to replace the outcome the player actually achieved,
an increase in the value of at least one prize that is available for the player to win,
an increase in the number of prizes that are available for the player to win,
a waiver of an entry fee for playing a game on the gaming Web site,
a reduction of an entry fee for playing a game on the gaming Web site, and
a change in a rule for playing a game on the gaming Web site, wherein the change favors the player.

5. The method of claim 2, wherein the benefit comprises an amount of currency.

6. The method of claim 5, wherein the amount of currency comprises at least one of an amount of monetary currency and an amount of alternate currency.

7. The method of claim 2, wherein the event which triggers the presentation of an offer comprises at least one of:
the player's achievement of at least a predetermined score;
the player's lack of achievement of at least a predetermined score;
the player's obtainment of a predetermined outcome while playing the game on the gaming Web site,
the player's lack of obtainment of a predetermined outcome while playing the game on the gaming Web site;
the player's payment of an entry fee for playing a game on the gaming Web site;
the player's initiation of providing an entry fee for playing a game on the gaming Web site;
the player's refusal to provide an entry fee for playing a game on the gaming Web site;
the player's logging on to the gaming Web site;
the player's logging off from the gaming Web site; and
the player's entry into a predetermined section of the gaming Web site.

8. The method of claim 2, further comprising:
receiving a payment identifier from the player, for use in charging a penalty to the player if
the player accepts the offer,
the player is provided with the benefit defined by the offer, and
the player does not perform the activity defined by the offer.

9. The method of claim 2, wherein the step of determining an offer comprises:
selecting an activity from a set of available activities; and
selecting a benefit from a set of available benefits.

10. The method of claim 9, wherein at least one of the step of selecting an activity and the step of selecting a benefit comprises randomly selecting.

11. The method of claim 9, further comprising:
assigning a value to each activity in the set of activities;
assigning a value to each benefit in the set of benefits; and
selecting a benefit and an activity such that the value corresponding to the selected benefit is at least equal to the value corresponding to the selected activity.

12. The method of claim 11, wherein the value assigned to each activity and the value assigned to each benefit comprises a monetary value.

13. The method of claim 11, wherein the step of assigning a value to each activity comprises:
assigning a value to an activity of the set of activities based on at least one of
a time for completion of the activity;
an amount of effort required for completing the activity;
a perceived burden associated with committing to the activity; and
feedback from other customers who have previously committed to the activity.

14. The method of claim 2, further comprising:
receiving, before the step of presenting, an indication of the subsidy from the party subsidizing the benefit.

15. The method of claim 14, further comprising:
receiving, from the party subsidizing the benefit, an indication of the activity.

16. The method of claim 2, wherein the step of determining an offer comprises:
determining a benefit such that a cost of providing the benefit does not exceed a value of the subsidy.

17. The method of claim 2, wherein the step of determining that the player has performed the activity comprises:
receiving, from an entity that is tracking performance of the activity, an indication that the player has performed the activity.

18. The method of claim 17, wherein the step of receiving, from an entity that is tracking performance of the activity, an indication, comprises:
receiving, from the party that is subsidizing the benefit, an indication that the player has performed the activity.

19. The method of claim 2, wherein the activity comprises at least one of:
purchasing a product or service from an entity other than an operator of the gaming Web site;
purchasing a product or service from an operator of the gaming Web site;
using a product or service;
testing a product;
participating in a free trial of a service;
answering at least one survey question;
visiting a retailer; and
considering information.

20. The method of claim 2, wherein the step of presenting comprises:
outputting the offer to the player via a display screen of a player device.

21. The method of claim 2, wherein the step of presenting comprises:
causing an employee to contact the player and verbally present the offer to the player.

22. A computer readable medium storing data in a computer readable format, the data representing:
at least one event that triggers the presentation of an offer to a player of a gaming Web site,
at least one benefit to be provided to a player of a gaming Web site;
at least one activity to be performed by a player of the gaming Web site; and
at least one rule for use in creating the offer by pairing at least one activity with at least one benefit.

23. The computer readable medium of claim 22, the data further representing:
at least one subsidy for funding a benefit, the at least one subsidy being associated with at least one activity.

24. An apparatus, comprising:
a first device, which includes
the medium of claim 19,
a processor operable to read data from the medium, and a plurality of player devices in communication with the first device.

25. The apparatus of claim 24, further comprising:
a plurality of subsidizer devices in communication with the first device.

26. A method, comprising:
receiving, from a subsidizing entity, an indication of a subsidy and an indication of a corresponding activity,
wherein the activity comprises an activity that, if performed by a player of a gaming Web site, results in a value being realized by the subsidizing entity;
selecting at least one benefit;
creating an offer for presentation to the player of the gaming Web site by pairing the activity with the at least one benefit,
wherein the at least one benefit is to be provided to the player if the player commits to the corresponding activity; and
wherein the benefit is selected such that a cost associated with providing the benefit to the player does not exceed a value associated with the subsidy.

27. The method of claim 26, further comprising:
identifying a player to whom the offer is to be presented; and
wherein the step of selecting comprises:
selecting the benefit based on at least one characteristic associated with the player.

28. The method of claim 26, wherein the step of determining a benefit comprises:
selecting a benefit from a set of available benefits.

29. The method of claim 28, wherein the set of benefits comprise benefits that have been made available for inclusion in offers by an operator of the gaming Web site.

30. The method of claim 26, wherein the activity comprises a purchase of a product or service from the subsidizing entity.

31. The method of claim 30, further comprising:
outputting the offer to the player;
determining that the player has accepted the offer;

32. The method of claim 31, further comprising:
collecting payment from the player for the product or service; and
providing to the subsidizing entity at least a portion of the payment.

33. The method of claim 31, further comprising:
notifying the subsidizing entity that the player has accepted the offer.

34. The method of claim 26, further comprising:
receiving, from the subsidizing entity, the subsidy.

35. The method of claim 34, wherein the step of receiving comprises:
receiving, once the player commits to the activity, at least a portion of the subsidy.

36. The method of claim 34, wherein the step of receiving comprises:
receiving, once the player performs the activity, at least a portion of the subsidy.

37. The method of claim 26, further comprising:
receiving, from the subsidizing entity, an indication of a number of players who must commit to the activity in order for the subsidy to be provided to an operator of the gaming Web site.

38. The method of claim 37, wherein the number is a minimum number.

39. The method of claim 26, further comprising:
receiving, from the subsidizing entity, an indication of a number of players who must be presented with the offer defining the activity in order for at least a portion of the subsidy to be provided to an operator of the gaming Web site.

40. The method of claim 37, wherein the number is a minimum number.

41. The method of claim 26, wherein the benefit comprises at least a portion of the subsidy.
